(19) United States
(12) Patent Application Publication
(10) Pub. No.: US 2012/0053981 A1
(43) Pub. Date: Mar. 1, 2012

(54) Risk Governance Model for an Operation or an Information Technology System

(75) Inventors: Margaret Lipps, Charlotte, NC (US); Thomas J. Sorrells, Wilmington, DE (US); Mary Riley, Charlotte, NC (US)

(73) Assignee: Bank of America Corporation, Charlotte, NC (US)

(21) Appl. No.: 12/873,914

(22) Filed: Sep. 1, 2010

(51) Int. Cl. G06Q 10/00

(52) U.S. Cl. 705/7.28

(57) ABSTRACT

A computer system assessing risks for a joint venture. A risk, e.g., a technology or operational risk, may be associated with an infrastructure or an application that supports one or more operations of the joint venture, where the infrastructure or application may encompass an information technology system for the joint venture. A risk assessment computer system obtains risk information for identified risks in the information technology system, where the joint venture may support separate operations for first and second partner businesses on the information technology system. Identified risks may be owned by the joint venture or by one or more partner businesses and assigned accordingly. The risk assessment computer system may prioritize identified risk according to risk scores. When a control that is associated with a high priority risk category is not installed, a mitigation plan may be tracked to eliminate a high risk control gap.

### FIELD

Aspects of the embodiments relate to a computer system that provides a risk assessment for an operation system, including an information technology (IT) system for a joint venture with two or more partner businesses.

### BACKGROUND

Risk management is a process that allows an information technology (IT) manager (that may encompass any associate within or outside of a technology and operations domain) to balance the operational and economic costs of protective measures while protecting the operations and the IT system and data that support the mission of an organization. Risk is the net negative impact of the exercise of vulnerability, considering both the probability and the impact of occurrence. However, the risk management process may not be unique to the operations or IT environment; pervading decision-making in all areas of our daily lives. For example, a homeowner may decide to have a home security system installed and pay a monthly fee to a service provider to have the security system monitored for protecting the homeowner's property. The homeowner weighs the cost of system installation and monitoring against the value of household goods and homeowner's safety, which is a fundamental “mission” need.

An organization typically has a mission. In this digital era, an organization often uses an automated IT system to process information for better support of the organization's mission. Consequently, risk management plays an important role in protecting an organization's information assets. An effective risk management process is an important component of a successful IT security program. The principal goal of an organization's risk management process should be to protect the organization and its ability to perform the mission, not just its IT assets. Thus, the risk management process should not be treated primarily as a technical function carried out by the IT experts who operate and manage the IT system but as an essential management function of the organization.

The objective of performing risk management is to enable the organization to accomplish its mission(s) (1) by better securing the operations and IT systems that store, process, or transmit organizational information; (2) by enabling management to make well-informed risk management decisions to justify the expenditures that are part of an IT budget; and (3) by assisting management in authorizing (or accrediting) the IT systems on the basis of the supporting documentation resulting from the performance of risk management.

### BRIEF SUMMARY

Aspects of the embodiments address one or more of the issues mentioned above by disclosing methods, computer readable media, and apparatuses that assess risks for joint venture. A risk, e.g., a technology or operational risk, may be associated with infrastructure or applications that support one or more operations of the joint venture, where the infrastructure or applications may comprise an information technology (IT) system for the joint venture.

According to an aspect of the invention, a risk assessment computer system obtains risk information for identified risks in an information technology system in a joint venture for first and second businesses. The joint venture may support separate operations on the information technology system. Identified risks may be owned by the joint venture or by one or more partner businesses and assigned accordingly.

According to another aspect of the invention, a risk assessment computer system prioritizes identified risk according to risk scores. When a control that is associated with a high priority risk category is not installed, a mitigation plan is tracked to eliminate the high risk control gap.

According to another aspect of the invention, identified risks are partitioned by a plurality of core attributes for a risk model. The identified risks may also be partitioned differently such as by internal risk categories.

According to another aspect of the invention, the identified risks may be summarized by a risk scorecard. The risk scorecard may include risk levels for different risk categories as well as the direction of risk level changes for the associated risks. The scorecard may also include a prioritization of the risks for the joint venture as well as for one or more of the partner businesses.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 shows a flow chart for analyzing a risk based on a specified risk framework in accordance with an aspect of the invention.

FIG. 4 shows a flow chart for determining a risk score for a specified risk in accordance with an aspect of the invention.

FIG. 5 shows a flow chart for determining a residual score for a specified risk in accordance with an aspect of the invention.

FIG. 6 shows a flow diagram for determining the disposition of a risk in accordance with an aspect of the invention.

FIG. 7 shows an illustrative screen shot for a summary of a risk in accordance with an aspect of the invention.

FIG. 8 shows an illustrative screen shot for a mitigation of a risk in accordance with an aspect of the invention.

FIG. 9 shows an illustrative screen shot in which risks are viewed by hierarchy in accordance with an aspect of the invention.

FIG. 10 shows an illustrative screen shot for a control inventory summary in accordance with an aspect of the invention.

FIG. 11 shows an illustrative screen shot for control assessment in accordance with an aspect of the invention.

FIG. 12 shows an illustrative bar chart for risk status in accordance with an aspect of the invention.

FIG. 13 shows an illustrative bar chart for risk status in accordance with an aspect of the invention.

FIG. 14 shows an illustrative bar chart for identified process weaknesses in accordance with an aspect of the invention.

FIG. 15 shows an information technology (IT) system for a joint venture in accordance with an aspect of the invention.

FIG. 16 shows a process map for supporting a joint venture in accordance with an aspect of the invention.

FIG. 17 shows a risk identification template in accordance with an aspect of the invention.

FIG. 18 shows an illustrative screen shot for a risk summary in accordance with an aspect of the invention.

FIG. 19 shows a flow chart for assessing risks for a joint venture in accordance with an aspect of the invention.

FIGS. 20A-D shows a risk model in a joint venture in accordance with an aspect of the invention.

FIG. 21 shows a summary for risks by core attributes in a joint venture in accordance with an aspect of the invention.

FIG. 22 shows a summary for risks by internal risk categories in a joint venture in accordance with an aspect of the invention.

FIG. 23 shows risks with a highest risk level for a partner in a joint venture in accordance with an aspect of the invention.

FIG. 24 shows risks with a highest risk level for a joint venture in accordance with an aspect of the invention.

FIG. 25 shows a list of risks associated with the people core attribute in accordance with as aspect of the invention.

### DETAILED DESCRIPTION

In accordance with various aspects of the invention, methods, computer-readable media, and apparatuses are disclosed for assessing a risk for an organization. The risk, e.g., a technology or operational risk, may be associated with infrastructure or applications that support one or more operations of a joint venture, where the infrastructure or applications may comprise an information technology (IT) system for the joint venture.

With an aspect of the invention, a risk assessment computer system obtains risk information for identified risks in an information technology system in a joint venture for first and second partner businesses. The joint venture may support separate operations on the information technology system. Identified risks may be owned by the joint venture itself or by one or more partner businesses and assigned accordingly.

With another aspect of the invention, a risk assessment computer system prioritizes identified risk according to risk scores. When a control that is associated with a high priority risk category is not installed, a mitigation plan is tracked to eliminate the high risk control gap.

With another aspect of the invention, a risk management tool provides identification, assessment, disposition, monitoring, mitigation, and reporting of known risk items across an IT system and as well as processes, people, and other systems associated with the IT system. The risk management tool may also map known risk items into a standard, universally recognized risk framework, including the Information Technology Infrastructure Library (ITIL), the Control Objectives for Information and related Technology (COBIT), and the risk management framework specified by the United States National Institute of Standards and Technology (NIST).

With traditional systems, the identification and assessment of risks are typically performed on a disjointed basis, e.g., over a division of an organization. For example, a financial organization may support different operations, including, electronic commerce, mortgage loans, car loans, global banking, and credit cards. Consequently, risk analysis by traditional systems is often inconsistent with variances over the entire organization. With an aspect of the invention, risk management is performed on a centralized basis. For example, a list of risks may be defined as impacting the entire organization rather than a division of the organization. Moreover, known risk items may be associated with different risk frameworks, thus tailoring the reporting of identified risks and the effects on the organization based on the audience of the report (e.g., IT operations associates, internal auditors, external auditors, regulatory bodies, and government agencies).

With an aspect of the invention, the risk management tool may identify a root cause, through a defined root cause dictionary, based on a known identified risk or the associated risk category of the identified risk. For example, the identified risk may be mapped to ITIL process (risk category) “capacity management,” which may in turn be mapped to the root cause “insufficient capacity on server.” This capability enables analysis of the operating environment and the ability to identify the main areas of risk or risk focus as well as helping to determine if current controls are ineffective and need improving or if controls are missing and new controls need to be implemented.

With another aspect of the invention, the risk management tool provides risk reports that facilitate a common risk language between IT operations associates (e.g., ITIL), between internal auditors, external auditors and regulatory bodies (e.g., COBIT), and between government agencies (e.g., NIST risk management framework). The risk management tool may facilitate cross analysis and correlation between known risk items and facilitate the identification of recurring risk themes and trends.

According to an aspect of the invention, risk management capabilities include consistent assessment, measurement, mitigation, and monitoring of known risks. A risk management computer system may be scalable for portability when connecting to risk management tools as the tools become available. The risk management computer system may also act as a system of record for identifying all E2E technology and operations key controls within a “Controls Inventory” and subsequent periodic assessment, to ensure effectiveness of these controls, through a “Controls Assessment Program.” The risk management computer system may identify and track known risks by financial hierarchy and align known risks into standardized risk frameworks. Consequently, consistent risk ratings may be generated for more effective prioritization and for ensuring consistent scoring of risks. Self-identified risks may be aligned to audit issues to facilitate proactive remediation and cross analysis of risks.

According to an aspect of the invention, key stakeholders (e.g., first line of defense (LOD)—lines of business (LOB), second LOD—governance and control, and third LOD—audit) of known risks may be identified.

According to an aspect of the invention, customized reporting for the known risk items may be generated and e-mail notifications sent out to relevant associates when new risk items are either identified or when risk items change status. The reporting may assist with enhancing risk profile management.

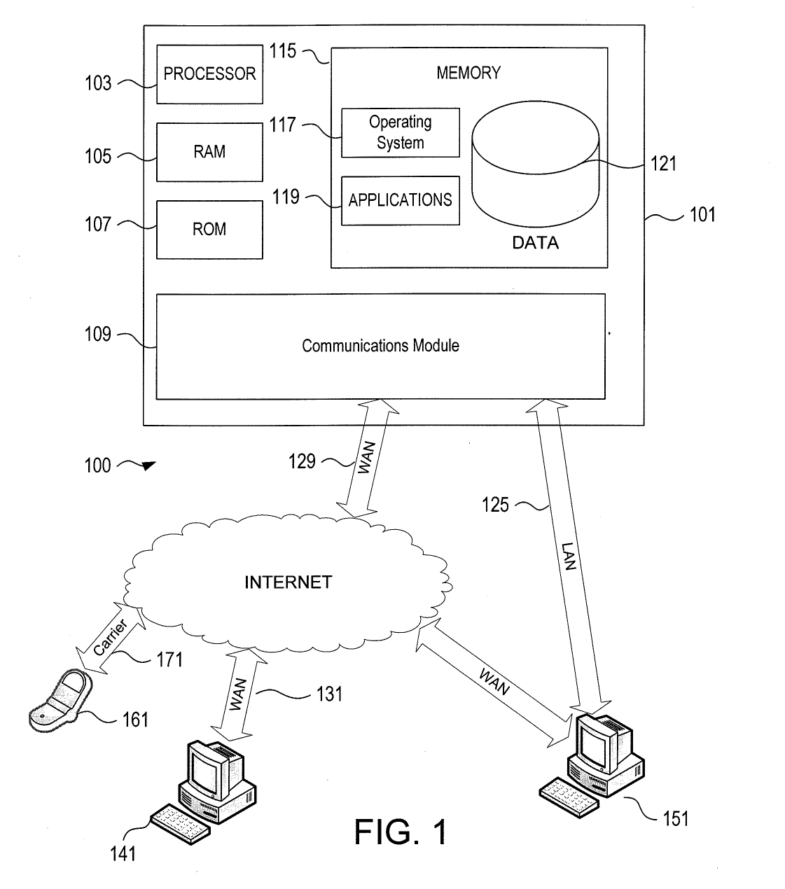

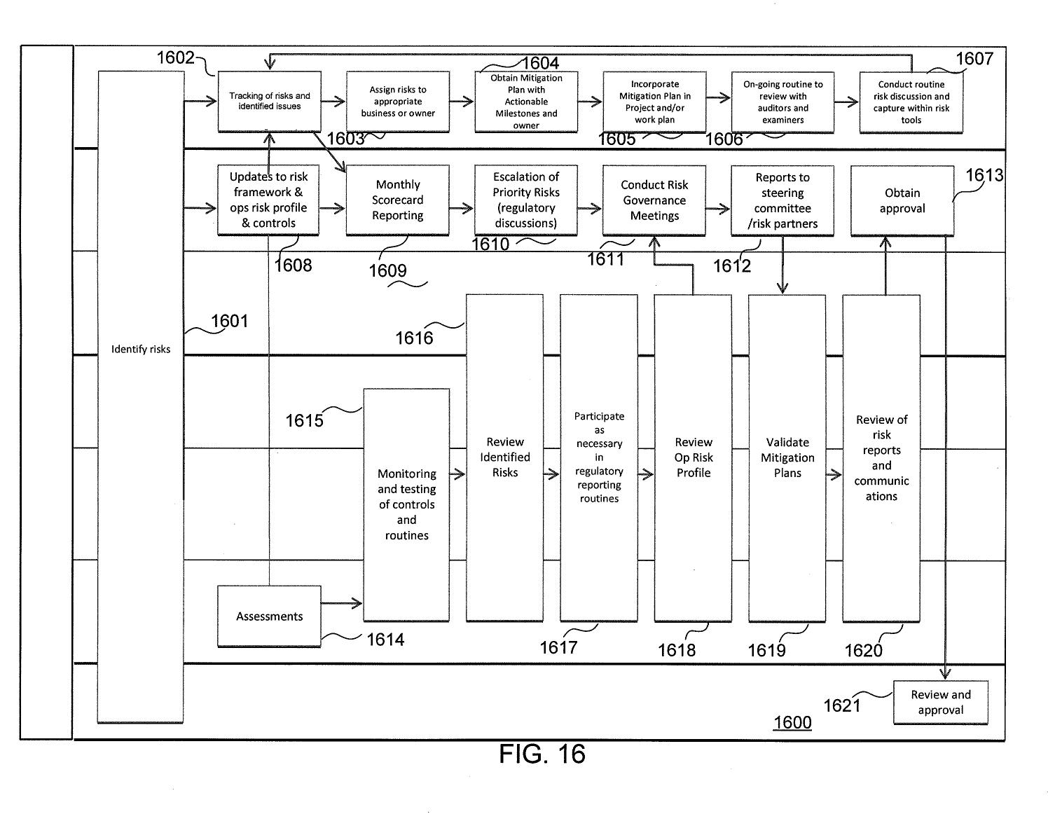

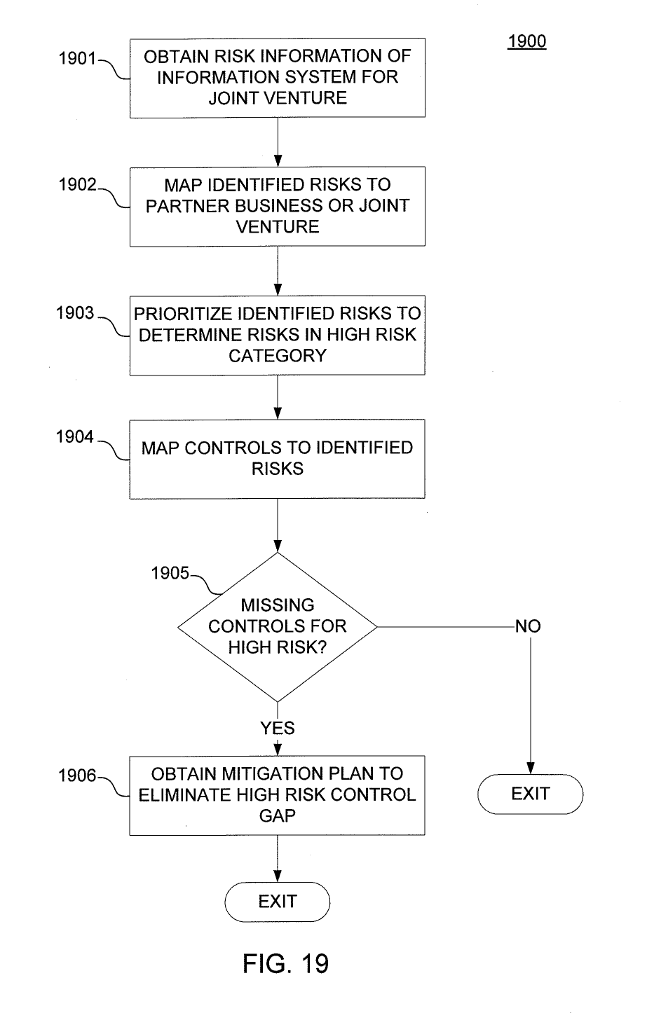

FIG. 1 illustrates an example of a suitable computing system environment 100 (e.g., for processes 1600 and 1900 as shown in FIGS. 16 and 19, respectively) that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of risk information including attributes about identified risks, characteristics about different risk frameworks, and controls for reducing risk levels that may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

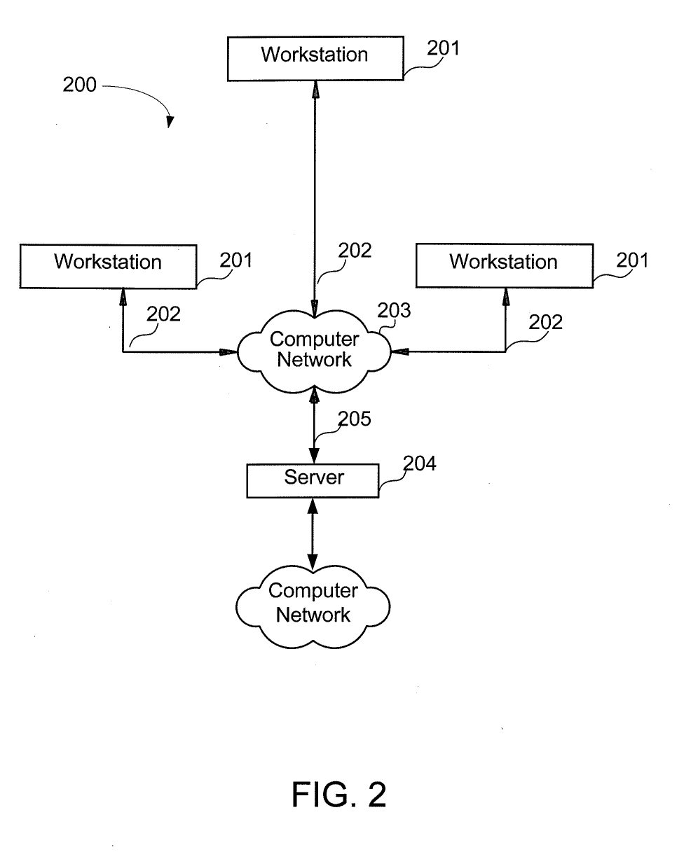

Referring to FIG. 2, an illustrative system 200 for implementing methods according to the present invention is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc. Connectivity may also be supported to a CCTV or image/iris capturing device.

The steps that follow in the Figures may be implemented by one or more of the components in FIGS. 1 and 2 and/or other components, including other computing devices.

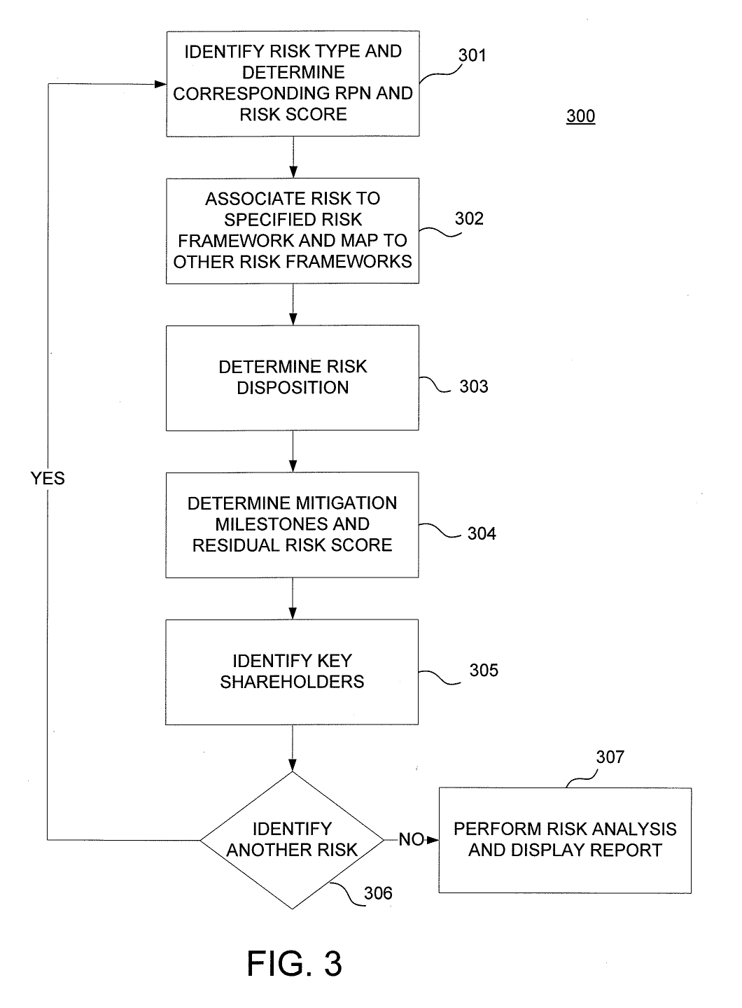

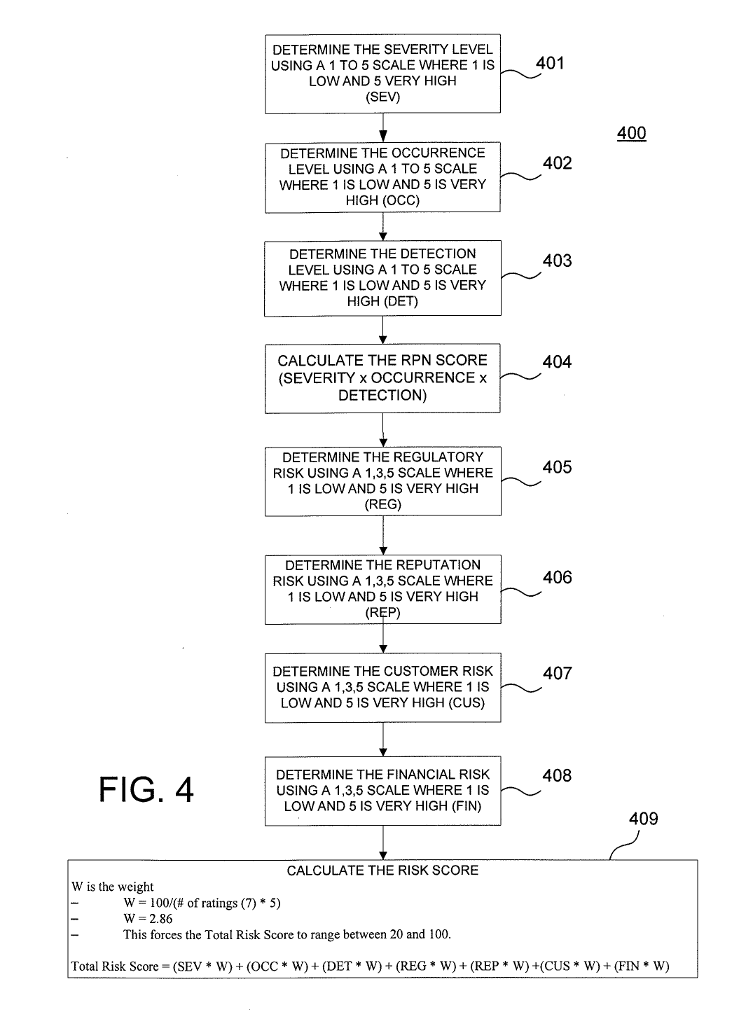

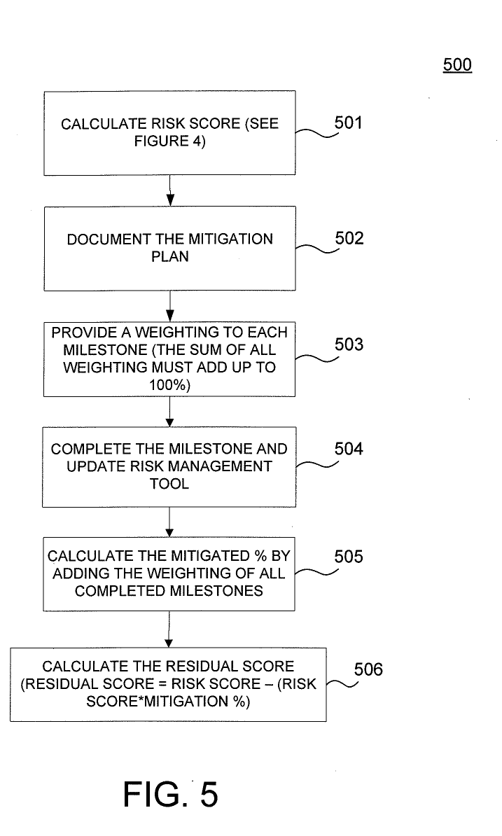

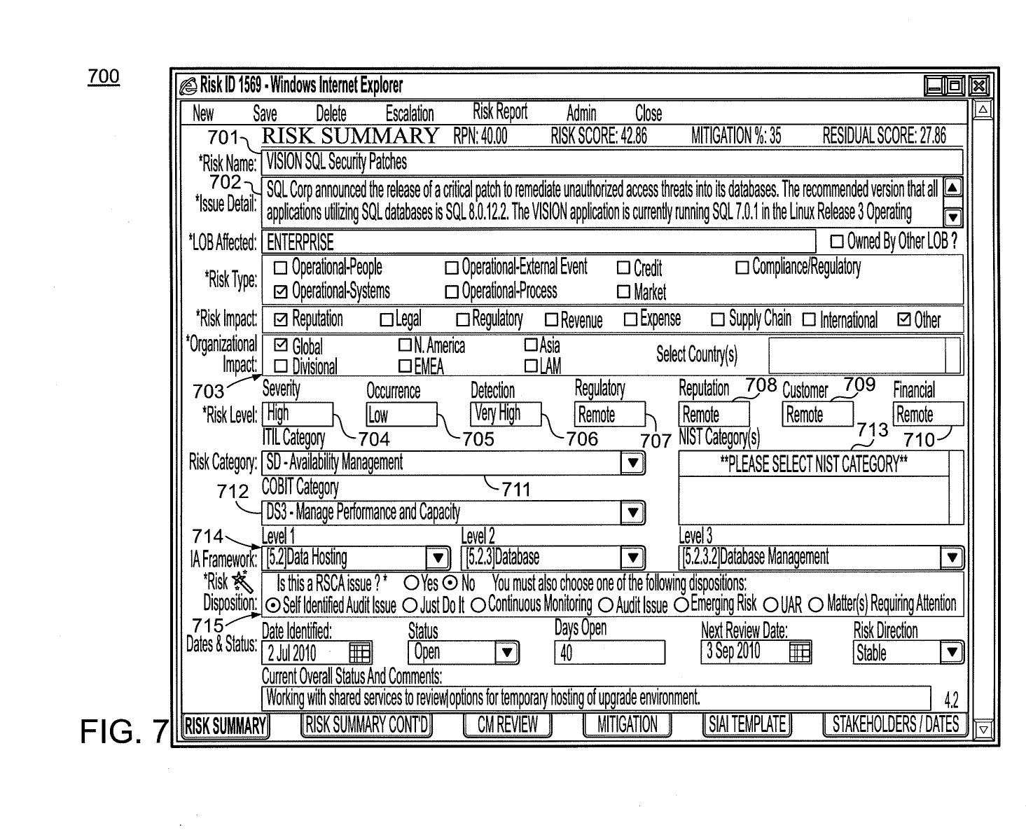

FIG. 3 shows flow chart 300 for measuring a risk in accordance with an aspect of the invention. At block 301 a risk is identified and the corresponding risk level (e.g., risk priority number (RPN) and the risk score), as will be further discussed with FIG. 4, are determined from risk information that may be entered by a user as will be further discussed with FIG. 7. With some illustrative embodiments, possible known risks may number in the hundreds, where each risk is associated with a risk category (commonly known as a risk framework). An illustrative operational risk may be “Default database accounts with default passwords” that may be entered in various ways, including a free formatted text field (risk name 701 as shown in FIG. 7), a pop-up menu (not explicitly shown), or by matching the entered text to a list of defined risks (not explicitly shown).

At block 302, the identified risk is mapped to a specified risk framework by associating the identified risk to a process within a risk category (framework) (e.g., Demand Management in risk category 711 as shown in FIG. 7). Embodiments may support different frameworks including Information Technology Infrastructure Library (ITIL), Control Objectives for Information and related Technology (COBIT), and the risk management framework specified by the United States National Institute of Standards and Technology (NIST).

Information Technology Infrastructure Library (ITIL) is a set of concepts and practices for Information Technology Services Management (ITSM), IT development, and IT operations. ITIL gives detailed descriptions of a number of important IT practices and provides comprehensive checklists, tasks and procedures that any IT organization may tailor to its needs. ITIL is published in a series of books, each of which covers an IT management topic. Information Technology Infrastructure Library (e.g., ITIL v3) encompasses service strategy, service design, service transition, service operation, and continual service improvement.

ITIL service strategy is typically associated with clarification and prioritization of service-provider investments in services. More generally, service strategy focuses on helping IT organizations improve and develop over the long term. Service strategy relies upon a market-driven approach. Key topics covered include service value definition, business-case development, service assets, market analysis, and service provider types. Different processes are associated with service strategy, including service portfolio management, demand management, IT financial management, and supplier management.

ITIL service design is associated with the design of IT services, processes, and other aspects of the service management effort. Service design within ITIL may encompass the elements relevant to technology service delivery, rather than focusing solely on design of the technology itself. Service design may address how a planned service solution interacts with the larger business and technical environments, service management systems required to support the service, processes that interact with the service, technology, and architecture required to support the service, and the supply chain required to support the planned service. Processes associated with service design include service catalog management, service level, management, risk management, capacity management, availability management, IT service continuity management, information security management, compliance management, IT architecture management, and supplier management.

ITIL service transition relates to the delivery of services required by a business into live/operational use and often encompasses the project side of IT. Associated processes include service asset and configuration management, service validation and testing, evaluation, release management, change management, and knowledge management.

ITIL service operation relates to achieving the delivery of agreed levels of services both to end-users and the customers (where “customers” refer to those individuals who pay for the service and negotiate the SLAs). Service operation may be the part of the lifecycle where the services and value is actually directly delivered. Also, the monitoring of problems and balance between service reliability and cost may be considered. Service operation may include technical management, application management, operations management and service desk as well as responsibilities for staff engaging in service operation. Associated processes include event management, incident management, problem management, request fulfillment, and access management.

ITIL continual service improvement (CSI) aligns IT services to changing business needs by identifying and implementing improvements to the IT services that support business processes. The perspective of CSI on improvement is the business perspective of service quality, even though CSI aims to improve process effectiveness, efficiency, and cost effectiveness of the IT processes through the whole lifecycle. To manage improvement, CSI should clearly define what should be controlled and measured. Associated processes include service level management, service measurement and reporting, and continual service improvement.

A process within a standard risk framework may be referred to as a risk category. For example, a user may identify a risk “VISION SQL Security Patches” in field 701 as shown in FIG. 7. The risk may be associated with ITIL risk category “Availability Management” 711 (associated with ITIL service design as described above), which in turn maps to COBIT risk category “Manage Performance and Capacity” 712.

Control Objectives for Information and related Technology (COBIT) is another risk framework, in which a set of best practices (framework) for information technology (IT) management was created by the Information Systems Audit and Control Association (ISACA) and the IT Governance Institute (ITGI) in 1996. COBIT provides managers, auditors, and IT users with a set of generally accepted measures, indicators, processes and best practices to assist them in maximizing the benefits derived through the use of information technology and developing appropriate IT governance and control in a company. Its mission is to research, develop, publicize and promote an authoritative, up-to-date, international set of generally accepted information technology control objectives for day-to-day use by business managers and auditors. Managers, auditors, and users benefit from the development of COBIT because it helps them understand their IT systems and decide the level of security and control that is necessary to protect their companies' assets through the development of an IT governance model. For example, COBIT version 4.1 has 34 high level processes that cover 210 control objectives categorized in four domains: planning and organization, acquisition and implementation, delivery and support, and monitoring and evaluation.

The NIST risk assessment framework provides guidance for securing the IT systems that store, process, or transmit organizational and for enabling management to make well-informed risk management decisions to justify the expenditures that are part of an IT budget; and (3) by assisting management in authorizing (or accrediting) the IT system on the basis of the supporting documentation resulting from the performance of risk management. For example, the NIST risk assessment framework is discussed in NIST Special Publication 800-30 “Risk Management Guide for Information Technology Systems.”

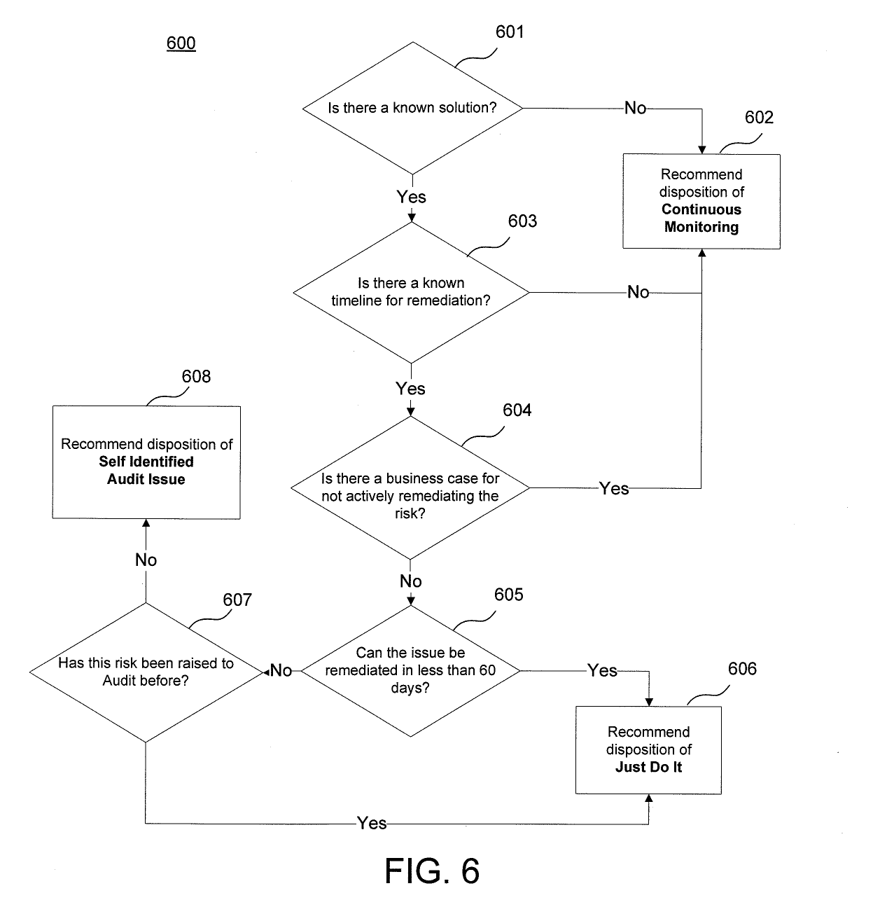

Referring to FIG. 3, at block 303, the risk disposition of the identified risk is determined. The risk disposition may be determined based on the severity of the risk, timeframe for remediating the risk and whether the risk has a known solution, as will be further discussed with FIG. 6. With some embodiments, a user is guided by a software wizard that reflects disposition criteria. When the user has answered the questions presented by the wizard, a risk disposition may be displayed to the user so that the user can enter it into field 715 as shown in FIG. 7. However with some embodiments, the wizard may automatically populate the disposition field without the user directly entering information.

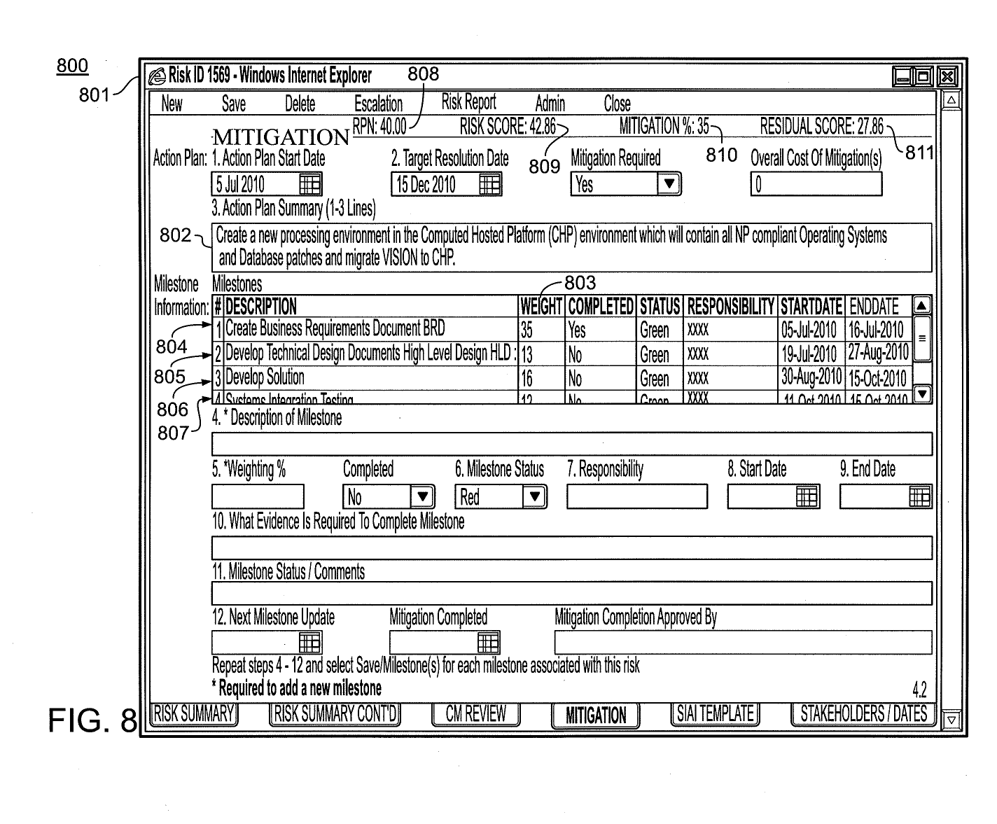

At block 304 mitigation milestones may be determined that will reduce the degree of risk for the identified risk when the milestones have been completed. For example, as shown in FIG. 8, mitigation milestones 804, 805, 806, 807 are entered with weights 35%, 13%, 16%, and 12%, respectively, for risk ID 801. (There may be more milestones that are not explicitly shown in FIG. 8, and consequently the sum of the weights for milestones 804, 805, 806, and 807 does not equal 100%.) When a mitigation milestone has been competed, risk score 809 is reduced based on the associated weight to obtain residual score 811.

At block 305, key stakeholders of known risks are identified. For example, key stakeholders may include lines of business (LOB) corresponding to a first line of defense (LOD), governance and control corresponding to a second LOD, and audit corresponding to a third LOD.

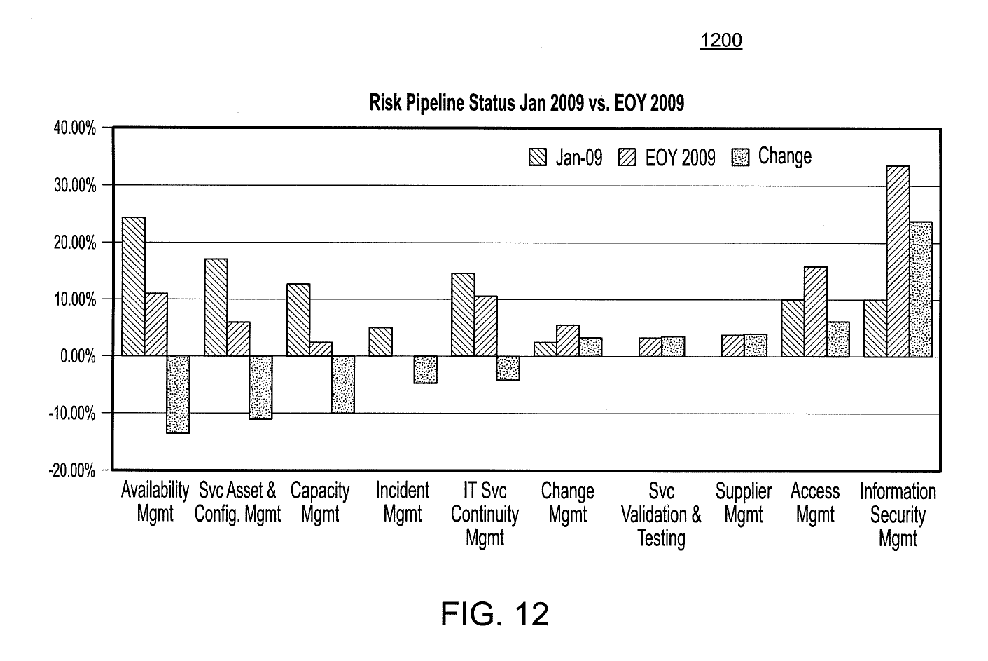

Block 306 determines whether additional risk items should be created or edited. If not, a risk report may be presented at block 307 that summarizes the identified risks based on one or more attributes. For example, a risk indicator is displayed for different ITIL processes (risk categories) in FIGS. 12-14. For illustrative screen shots 1200-1400, information security management 1202 has the largest number of risks with respect to the other risk categories both at the beginning of year 2009 as well as at the end of year 2009. While ITIL categories are displayed, another report may be generated with risk categories for other risk frameworks, e.g., COBIT or NIST, if the targeted audience of the report is different.

Risk Reporting and risk analysis reporting are typically two separate activities. For example, a risk management tool may provide risk reporting that may be filtered by disposition, RPN value, date values, hierarchy, accountability, and the like. Risk analysis reporting may be performed from the mapping of known risks into frameworks (risk categories/processes) and may assist to identify trends within the environment as well as the ability to identify, at any given point, where the highest areas of risk are.

FIG. 4 shows flow chart 400 for determining a risk score for a specified risk in accordance with an aspect of the invention. At blocks 401-403, the RPN value of the identified risk is determined by multiplying the severity level, occurrence level, and detection level together. Because each level may vary from 1 to 5, the RPN varies from 1 to 125, where the larger the RPN, the greater the risk level.

At blocks 405-408, additional risk factors are obtained, including an associated regulation risk measure, reputation risk measure, customer risk measure, and financial risk measure. The risk score is then determined at block 409 by multiplying each of the above seven risk factors by a weighting factor and then summing the seven resulting components. Consequently, the risk level varies from 20 to 100, where the larger the value, the greater the inherent degree of risk.

FIG. 5 shows flow chart 500 for determining a residual score for an identified risk in accordance with an aspect of the invention. At block 501, the risk score of the identified risk is determined at block 409 as shown in FIG. 4. A mitigation plan (e.g., mitigation milestones 804-807 as shown in FIG. 8) is entered and documented at block 502. Each milestone is weighted by a relative degree of importance at block 503, where the sum of all of the weighting factors equals 100%. With some embodiments, the mitigation milestones may not be completed in sequential order as entered mitigation milestones 804-807.

When a mitigation milestone is completed, an indication is entered through the risk management tool at block 504 so that the completed mitigation percentage is determined at block 505. At block 506, the residual score of the identified risk is determined by:

residual_score=risk score*(1−completed_mitigation_percentage) (EQ. 1)

FIG. 6 shows flow chart 600 for determining the risk disposition of a risk in accordance with an aspect of the invention. An identified risk is classified in one of a plurality of disposition categories. With the illustrative embodiment shown in FIG. 6, disposition categories include “Just Do It” (JDI), “Self Identified Audit Issue” (SIAI), “Urgent Audit Requirement” (UAR), and “Continuous Monitoring” (CM) based on disposition criteria.

At block 601, it is determined whether the identified risk has a known solution. If not, an indicator is generated at block 602 that is indicative of continuous monitoring. The indicator may be text, output to a user and/or automatic generation of the risk disposition in an appropriate field of a screen shot (e.g., risk disposition field 715 as shown in FIG. 7).

At block 603, flow chart 600 further determines whether there is a known timeline of remediation for the identified risk. If not, the recommended disposition is continuous monitoring at block 602. If so, process 600 determines whether there is a business case for not actively remediating the risk at block 604. If so, the recommended disposition is continuous monitoring at block 602. If not, process 600 determines whether the identified risk can be remediated in less than 60 days at block 605. If so, process 600 recommends the disposition “Just Do It” at block 606. If not, process 600 determines whether the identified risk has been raised to Audit before at block 607. If so, the recommended disposition is “Just Do It” (corresponding to block 606). If not, the recommended disposition is “Self Identified Audit Issue” (corresponding to block 608).

As previously discussed, a user may be guided by a software wizard that reflects disposition criteria. When the user has answered the questions presented by the wizard, a risk disposition may be displayed to the user so that the user can enter it into field 715 as shown in FIG. 7. However with some embodiments, the wizard may automatically populate the disposition field without the user directly entering information. With some embodiments, the wizard may associate an identified risk with one of the disposition categories when the following criteria are met:

JDI Disposition Category:
1) Has a known solution.
2) When initially identified, is generally a low risk, with an RPN of ≦27, which may be considered equivalent to a severity 3 audit issue.
(For example, a high level risk is defined as having an RPN≧64 and may equate to a Severity 1 Corporate Audit issue. A medium level risk is defined as having an RPN between 28 and 63 and may equate to a Severity 2 Corporate Audit issue. A low level risk is defined as having an RPN≦27 and may equate to a Severity 3 Corporate Audit issue. The RPN may be calculated by multiplying “Severity” by “Occurrence/Frequency” by “Detection,” where each element is rated on a 1 to 5 scale.)
3) Is rejected as an SIAI by Corporate Audit, but is still in need of remediation. Such risks can be any risk level or severity level.
4) May qualify as an SIAI, but can be remediated in <60 days.
5) Is not being addressed in an active project.
6) Is not categorized as a UAR.

The JDI disposition category may be directed to efforts to enhance existing effective controls (e.g., raising the bar).

SIAI Disposition Category:
1) Has a known solution.
2) Is typically considered to be a medium to high level risk
3) Requires longer than 60 days to remediate.
4) Is not being addressed in an active project.
5) Has not been raised to audit before as an audit or self-identified issue.
6) Meets one of the audit severity definitions.
7) Results from the absence of control or ineffective control.
8) When raised with an audit severity of 2 requires band 2 executive approval.
9) When raised with an audit severity of 1, requires band 2 and band 1 executive approval.
A business may have an associate hierarchy that is structured into bands 1 to 10 (where 1 is most senior and 10 is most junior). Risks with an RPN≧64 (corresponding to a possible severity 1 audit issue) may require both band 1 and band 2 approval and risks with an RPN between 28 and 63 may require band 2 approval.
10) Identify and address the root cause of the risk.
11) Ensure the sustainability of the remediation.

The SIAI disposition category may be directed to efforts to answering the question: “Where are we lacking controls or what controls are not working effectively?”

UAR Disposition Category:
1) Has a known solution.
2) Is a high risk.
3) Meets the definition of an audit severity 1.
4) Likely has a risk priority number (RPN)>=64.
5) Must be remediated in <30 days.
6) May be self-raised or raised by Corporate Audit.
7) May be a precursor to an audit finding.
8) May be a finding for remediation without leading to an audit issue.
9) If self-identified, cannot have been raised to audit before (by audit or self-identified).
10) Is not being addressed in an active project.
11) Results from the absence of control or ineffective control.
12) If self-identified, requires band 2 and band 1 executive approval.

CM Disposition Category:
1) Has no known solution and/or no known timeline for resolution.
2) May be any risk level, audit severity level or any risk priority number (RPN).
3) May include a risk that is being addressed in an active project.
4) May include a risk with documented analysis showing the cost to remediate outweighs the risk.

Continuous monitoring typically differs from risk acceptance and is not typically a means to bypass remediation of the risk item if remediation is considered too costly, resource intensive or inconvenient. Furthermore, continuous monitoring may entail periodic review of the risk, based on the level of risk, and may require the risk owner to report on progress towards mitigation or future elimination of the risk.

FIG. 7 shows illustrative screen shot 700 for a summary of a risk in accordance with an aspect of the invention. Screen shot 700 enables a user to create a new risk or edit an existing risk.

With the illustrative embodiment shown in FIG. 7, a user enters a risk name 701 of the identified risk with a description of the risk in field 702. Fields 701 and 702 may be entered as free-format text. However, some embodiments may provide a pop-up window that displays a list of possible risks so that the user may select one of the pre-defined risks.

The user may specify the organizational impact in area 703 by entering the affected regions and may further select one or more affected countries.

The user further provides risk information about the risk level in fields 704-710. With some embodiments, the risk priority number (RPN) is determined from severity measure 704, occurrence measure 705, and detection measure (ability to detect the risk) 706 by multiplying measures 704, 705, and 706, where each measure has an integer measure from 1 to 5. Consequently, the RPN of the identified risk has a value from 1 to 125, where the larger the RPN, the larger the risk level. As previously discussed, flow chart 400 (as shown in FIG. 4) further determines a risk score for the identified risk by combining the RPN with regulation measure 707, reputation measure 708, customer measure 709, and financial measure 710.

A user may select the ITIL risk category in field 711 by selecting one risk category that is associated with the identified risk. The ITIL risk category acts as the driver and may be mapped to the corresponding COBIT risk category or categories and NIST risk category or categories so that the corresponding risk category or categories are shown in fields 712 and 713. If more than one COBIT or NIST risk category is mapped to the ITIL risk category, than the user may select the appropriate risk category or categories shown in pop-up windows with fields 712 and 713.

In addition to associating the identified risk with a risk category for one or multiple risk frameworks, the identified risk may be mapped to a component of the organization's infrastructure architecture. While the risk category is typically specified in a standardized document, the organization's framework is often specific to the organization. The user may select one of the infrastructure components provided in a pop-up window with field 714. For example, an infrastructure component may correspond to data hosting, business intelligence tools, and management tools at different levels of the infrastructure architecture framework.

The risk disposition is included in field 715 as previously discussed with FIG. 6.

FIG. 8 shows illustrative screen shot 800 for a mitigation of a risk in accordance with an aspect of the invention. Screen shot 800 is typically displayed after the user has viewed screen shot 700 in order to enter a new risk or to edit an existing risk (corresponding to risk id 801). The action plan summary for mitigating the risk is entered as free-format text in field 802. As previously discussed, the risk level of the identified risk may be reduced by completing mitigation milestones (e.g., milestones 804-807). The risk level may be based on risk score 809, which in turn is determined from RPN 808 and measures 707-710 (as shown in FIG. 7). When a mitigation milestone has been completed, risk score 809 is reduced relative to weighting factor 803 associated with the mitigation milestone to obtain residual score 811. Typically, the larger weighting factor 803, the larger the effect of the mitigation milestone on the identified risk. Mitigation % 810 is the sum of weighting factors 803 for milestones that have been completed.

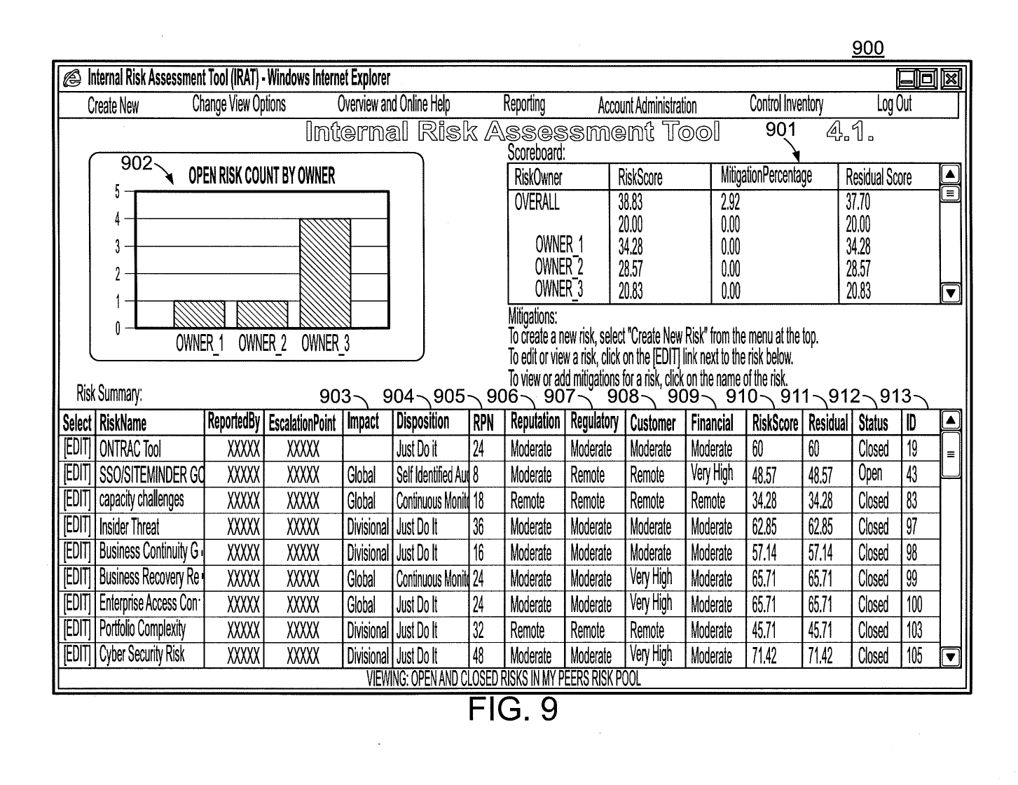

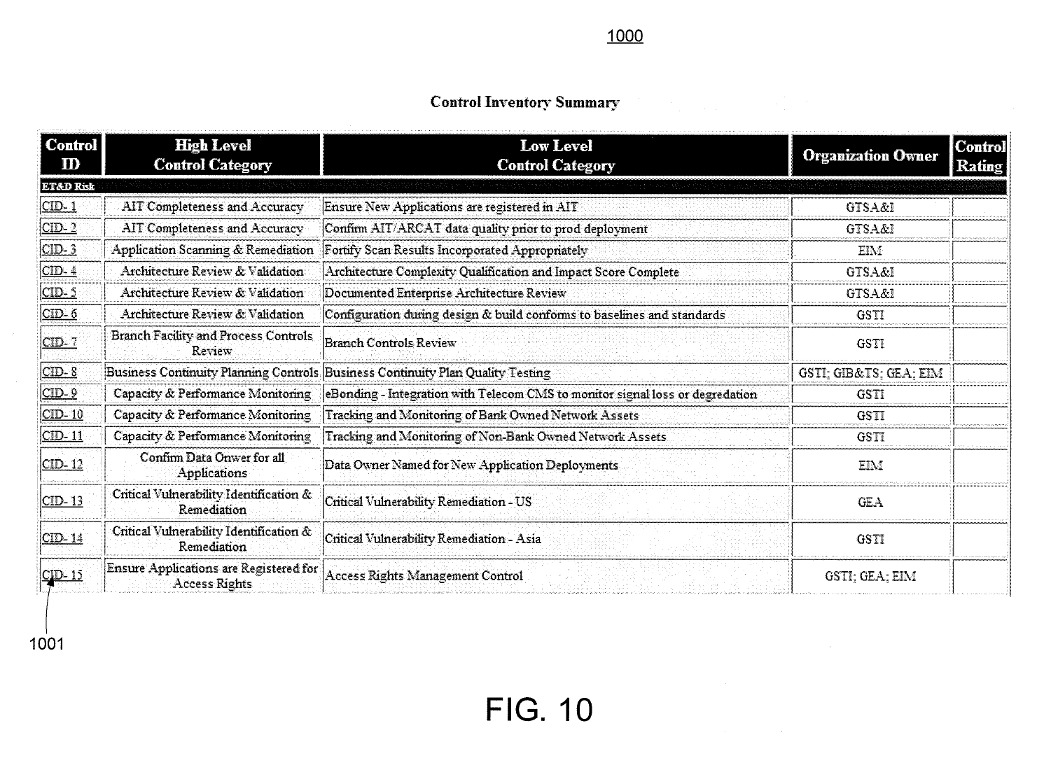

FIG. 9 shows illustrative screen shot 900 in which risks are viewed according to an organization's hierarchy in accordance with an aspect of the invention. For example, a manager may wish to view identified risks for a plurality of subordinates (owners) in the manager's organization. However, a member in the organization may be able only to view risks owned by the owner. Consequently, risk reports may be restricted to the user based on the hierarchy of the organization or by access level provisioning within the risk management tool.

Identified risks may be summarized by owner in scoreboard 901 and in bar graph 902. The user may click on one of the bars in bar graph 902 to obtain a risk summary for risks owned by the associated owner. The user may also sort the risk summary based on values associated with fields 903-913. For example, identified risks associated with a continuous monitoring disposition may be sorted to appear at top of the risk summary or identified risks may be sorted by RPN value, with the highest values at the top of the risk summary.

FIG. 10 shows illustrative screen shot 1000 for a control inventory summary in accordance with an aspect of the invention. Screen shot 1000 shows the key E2E controls (shown as a “Controls Inventory” or “System of Record”) that have been identified and are utilized in the organization's infrastructure to reduce the risk level. For example, entry 1001 corresponds to control id CID-15 that ensures applications are registered for access rights. The controls shown in screen shot 1000 are typically specific for an organization but may be mapped to standard, risk frameworks (ITIL, COBIT and NIST). A control may also be mapped to one or more known risks (either Self Identified or Audit raised) or to a country specific regulatory and/or legal requirement.

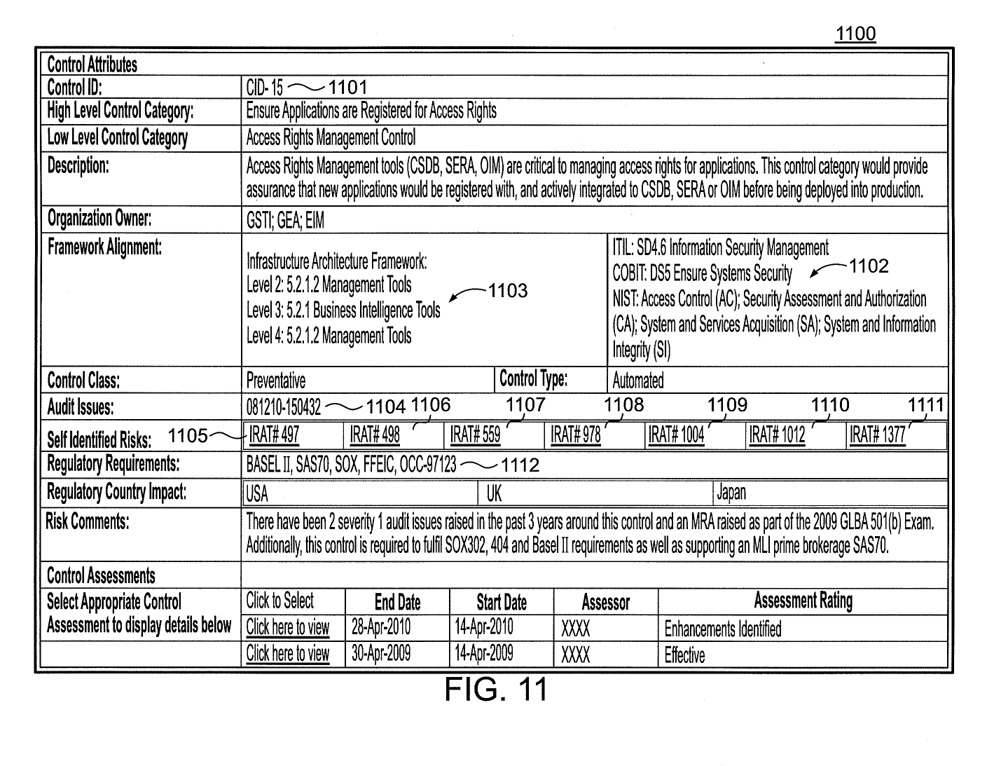

FIG. 11 shows illustrative screen shot 1100 for control assessment in accordance with an aspect of the invention. Screen shot 1100 provides specifics for control id 1101 (CID-15 corresponding to entry 1001 shown as in FIG. 10). Control CID-15 is associated with risk categories shown in area 1102 and with the infrastructure architecture framework shown in area 1103. The control may be mapped to known audit issues (e.g., audit issue 1104), to known self identified risks (e.g., risks 1105-1111), and to known regulatory and legal requirements 1112.

With some embodiments, a control assessment program may be supported in order to test the effectiveness of the controls on a periodic basis.

FIG. 12 shows illustrative bar chart 1200 for risk status based on different risk categories (e.g., ITIL processes) in accordance with an aspect of the invention. With the example shown in FIG. 12, for all known risk items identified as of January 2009, 56.1% were mapped to the ITIL processes of ‘availability management’, ‘service asset and configuration management’, and ‘IT service continuity management’. During the course of 2009, the organization launched the SIAI program to increase the number of risk items in the pipeline. This effort led to a 471% increase in the total number of risk items.

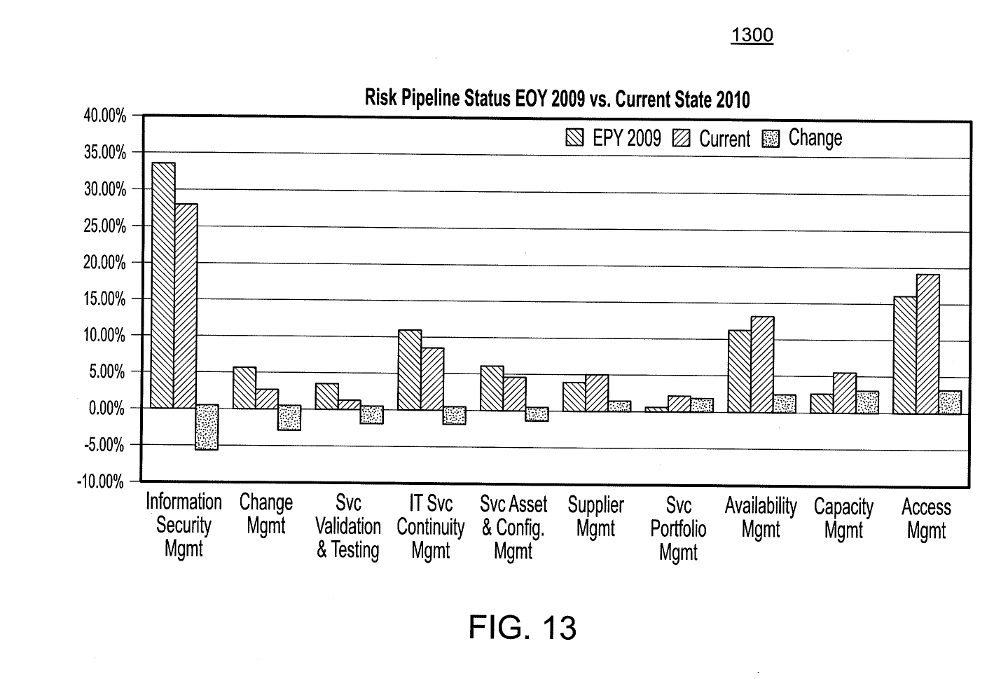

FIG. 13 shows illustrative bar chart 1300 for risk status comparing year 2010 with year 2009 in accordance with an aspect of the invention. Information security management, access management, and availability management accounted for 59% of all risks. In 2010, the organization drove down the number of information security management risks by 5.42%, change management risks by 3.08%, and service validation and testing risks by 2.36%.

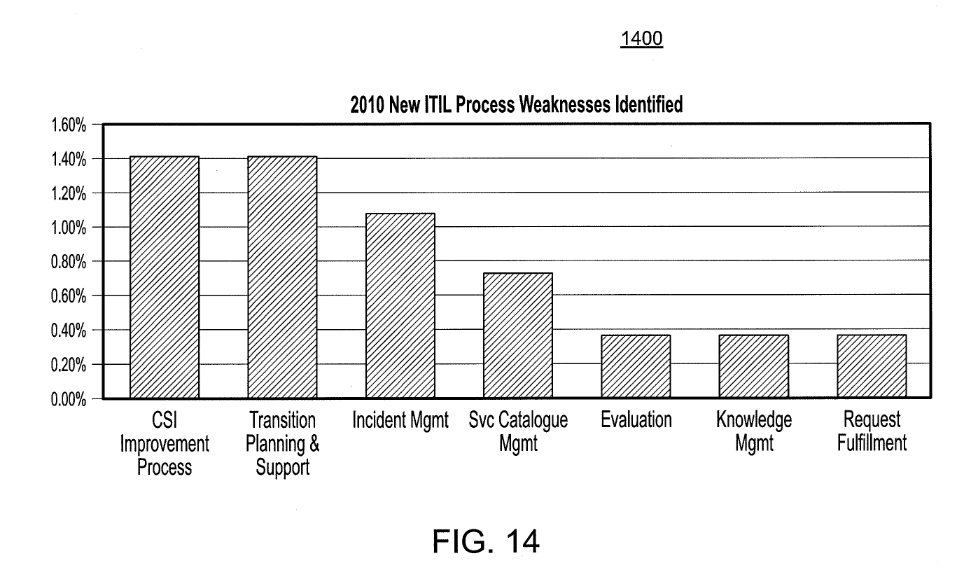

FIG. 14 shows illustrative bar chart 1400 for newly identified process weaknesses with an aspect of the invention. In year 2009 the organization identified the most risks in the following risk categories: information security management, access management, change management, supplier management, and service validation and testing. In year 2010 the organization raised 50 new risks with the following ITIL classification: capacity management, supplier management, access management, and availability management. With this example, access management, availability management, and capacity management continued to see increases in risks identified. Therefore, the organization may need to examine the ineffectiveness of existing controls. In year 2010, new ITIL process weaknesses were identified as follows: CSI improvement process, transition planning and support, incident management, service catalog management, evaluation, knowledge management, and request fulfillment.

While FIGS. 12, 13 and 14 show separate bar graphs 1200, 1300, and 1400, respectively, some embodiments may combine the bar graphs into an integrated screen shot to facilitate risk analysis reporting.

The above illustrative risk analysis helps to ensure that access controls are in place and enables the organization to provide a risk point of view (POV) as to which risks require immediate remediation focus. For example, password and ids criteria should be communicated to all associates to ensure passwords and ids are created with the prescribed criteria. Also, user access rights should be regularly self-audited in order to maintain rights with current associate responsibility. Vendor management should include implemented procedures for the administration of user security on the remote access products.

Also, access rights should be appropriately deactivated. System access for terminated/transferred employees should be removed on a timely manner in accordance with standards and baselines. The listing of terminated/transferred employees should be reviewed on a regular basis to ensure that the terminated/transferred employees have been removed from the system. Regarding availability management, the availability of the organization's resources, services, and components should continue to improve. Availability targets in all areas should be are measured and achieved to match or exceed the current and future agreed needs of the business in a cost effective manner. Regarding capacity management, the organization should focus on capacity and performance related issues, relating to both services and resources to match the capacity of IT to the agreed business demands. The organization should ensure that capacity is considered in the design state to successfully manage capacity.

Referring to FIGS. 7 and 8, various aspects of the invention are illustrated for identified risk SQL security patches (risk ID 1569) as entered in risk name 701. The identified risk is associated with issue 702 (release of critical patch to remediate unauthorized access threats into SQL databases). The risk is associated with ITIL Category 711 (Availability Management), which maps to COBIT Category 712 (Manage Performance and Capacity).

Risk levels are entered into fields 704-710, from which computer system 100 determines the RPN (shown with a value of 40 in field 808 as shown in FIG. 8), risk score (shown with a value of 42.86 in field 809), mitigation percentage (shown with a value of 30% in field 810), and residual score (shown with a value of 27.86 in field 811). The mitigation percentage reflects that mitigation milestone 804 (Create business requirement document) has been completed. However, milestones 805-807 and other milestones that are not explicitly shown in FIG. 8 are still pending.

Also, the risk disposition 715 is recommended to be Self Identified Audit Issue as determined by process 600.

The risk may be associated with one or more controls that may be shown in a control attribute screen shot (similar to screen shot 1100), where one of the self identified risks includes risk ID 1569.

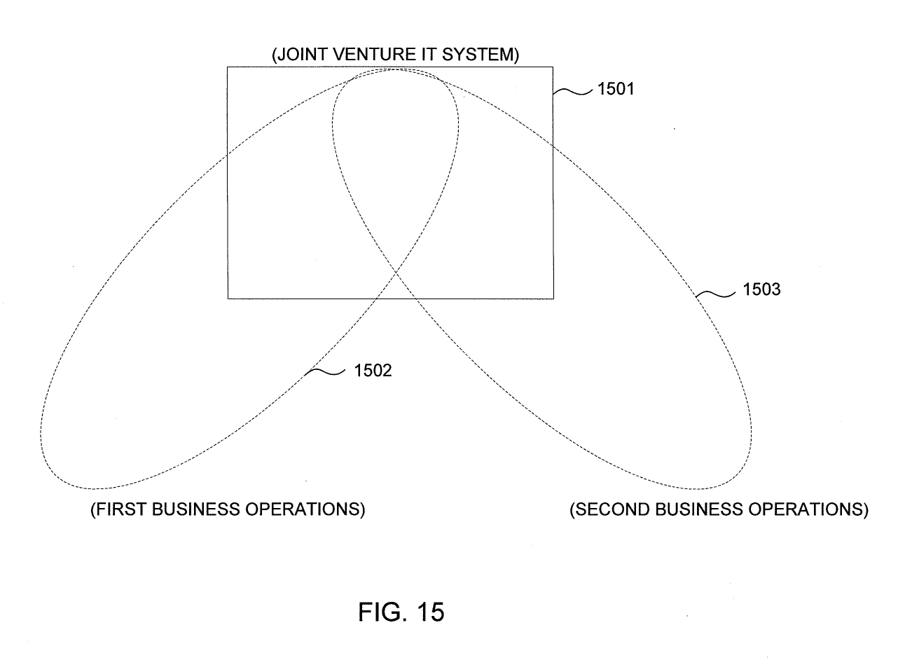

FIG. 15 shows information technology (IT) system 1501 for a joint venture in accordance with an aspect of the invention. IT system 1501 may support a joint venture (JV) for a plurality of businesses (partners), including a first business and a second business corresponding to first business operations 1502 and second business operations 1503, respectively. (A partner may denote first business and/or second business.) The plurality of businesses may include any number of businesses that is greater or equal to two. The first business and the second business may formalize the joint venture with a contract that specifies obligations for each business in the joint venture and may establish the joint venture as a separate business entity. The joint venture may be viewed as a third party by the first business and/or the second business.

A joint venture may be appealing to different businesses, including competitive business, because of economic reasons as well as synergistic reasons in the development and maintenance of IT system 1501. While utilizing common hardware and software resources on IT system 1501, business operations 1502 and business operations 1503 are typically separate order to preserve customer privacy and transparency to the customers of each business. While IT system 1501 is common for the joint risk, operations 1502 and 1503 are performed by the corresponding business. Consequently, operations 1502 and 1503 are typically different but may be modified by the joint venture.

While the joint venture support IT system 1501, identified risks may be common to both businesses or may be specific to the first business or the second business.

The first business and the second business may support the joint venture assigning seconded associates that work on the joint venture during some or all of time of the joint venture. For example, seconded associates from the first business and the second business may develop and/or maintain IT system 1501 during duration as specified by a contract for the joint venture. Subsequently, the seconded associates typically return to the partner businesses.

IT system 1501 may support different business operations, including an Automated Clearing House (ACH) where the businesses are financial institutions (e.g., banks). An Automated Clearing House is an electronic network for financial transactions in the United States. ACH typically processes large volumes of credit and debit transactions in batches, including ACH credit transfers (e.g., direct deposit payroll and vendor payments) and ACH direct debit transfers (e.g., consumer payments on insurance premiums, mortgage loans, and other kinds of bills). Also, debit transfers may also include new applications such as the Point-of-Purchase (POP) check conversion pilot program sponsored by NACHA (formerly the National Automated Clearing House Association) and the Electronic Payments Association. Both the government and the commercial sectors use ACH payments. Businesses are also increasingly using ACH to collect from customers online rather than accepting credit or debit cards. Rules and regulations governing the ACH network are established by NACHA (formerly the National Automated Clearing House Association) and the Federal Reserve (Fed).

Different banks may determine that IT system 1501 is mutually beneficial to each bank and consequently establish a joint partnership (referred as the joint venture) in the processing of ACH transactions. The different banks may have a significant overlap in footprint. Consequently, there may be significant overlap between the ACH origination and ACH receive numbers creating an opportunity to save money by treating them as “on we” items and not having to transmit the transactions over the existing ACH networks. In addition, combining the ACH back office functions of the banks may lead to a more cost effective process, allowing each bank to offer more competitive pricing as compared to going through the existing ACH networks. However, the joint venture may have a number of significant issues along the way to meet these expectations. The banks, for example, may have entrenched interests and competitive issues. Both banks may be highly competitive and have large ACH organizations with very different solutions. The joint venture may focus on the back office functions of ACH (corresponding to operations 1502 and 1503), while the two banks continue to compete and differentiate themselves with their front office capabilities.

Referring to FIG. 1, computing system environment (risk assessment computing system 100) obtains risk information about identified risks for a joint venture (e.g., IT system 1501) and to assess the risks.

While FIG. 15 shows IT system 1501, aspects of the invention may be directed to risk assessment that includes non-technology risks for an operational system. For example, known risk items may span IT system 1501 as well as processes, people, and other systems associated with IT system 1501. While aspects of the invention focus on joint ventures, the process map in FIG. 16 may be used for any operation or technology project, process or program.

FIG. 16 shows process map 1600 for supporting a joint venture in accordance with an aspect of the invention. Different types of businesses that are partners in the joint venture may be supported by process map 1600 including financial institutions, retailers, and manufacturers. Risk team members from partner companies typically work on integrated risk activities to ensure appropriate and most effective coverage of joint venture's controls.

Joint venture governance roles and responsibilities are typically assigned to different groups of the partner businesses and of the joint venture including lines of business, governance and control groups, corporate audit groups, and seconded associates of the joint venture.

A line of business (LOB) may have primary accountability for its operational risk management. Representatives may be selected across all governance functions to drive risk identification, prioritization, escalation and mitigation for partner business compliance, joint venture compliance, information security/business continuity, program execution, technological, and credit and operational risk. Representatives may be voting members of a risk and compliance steering committee.

A governance and control organization may be responsible for compliance and operational risk functions with other staff support groups (e.g., legal) and typically serves as an integral partner to businesses in performance and risk management.

A corporate audit group may perform independent testing to ensure the adequacy and effective execution of the joint venture. A representative from the corporate audit group may participate in a joint venture risk and compliance steering committee in a non-voting advisory capacity. Seconded associates may also serve on the risk and compliance steering committee to ensure appropriate linkage to the joint venture.

Referring to FIG. 16, process map 1600 supports a risk governance program to ensure the appropriate risk management of technology and operations responsibilities (e.g., associated with system 1501), including managing information protection policies and practices, managing risk that arises from systems and tools (e.g., by the introduction of new technologies into a business's infrastructure and data management), developing business continuity policies to mitigate potential operational risk, and reducing risks related to technology changes or events.

The risk governance program should be consistent with the operational risk programs of the enterprise and the lines of business to ensure consistency of coverage and regulatory compliance. A risk and compliance steering committee may use operational risk profiles to create a specific operational risk profile for the joint venture. A partner's supply chain governance program may be leveraged for ongoing risk management of the joint venture including contractual, financial, performance requirements, and related routines. The joint venture's operational risk profile may be assessed against the partner's risk policies and requirements, ITIL and COBIT risk frameworks, and current threat and risk environment as well as laws and regulations to ensure appropriate coverage.

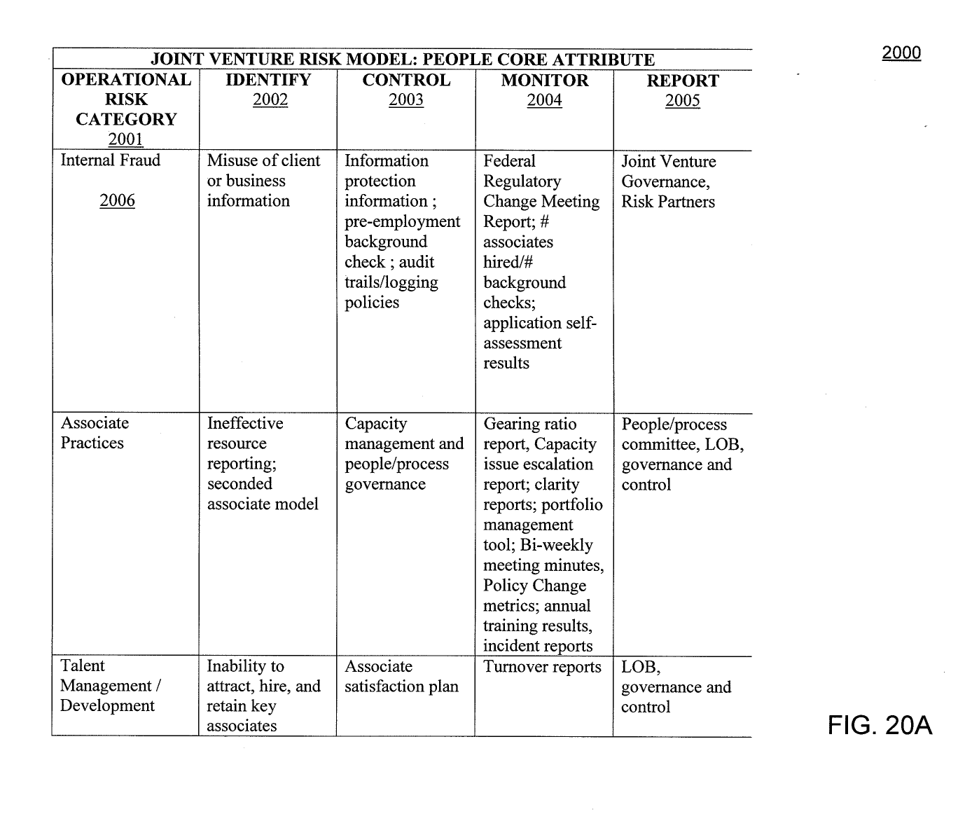

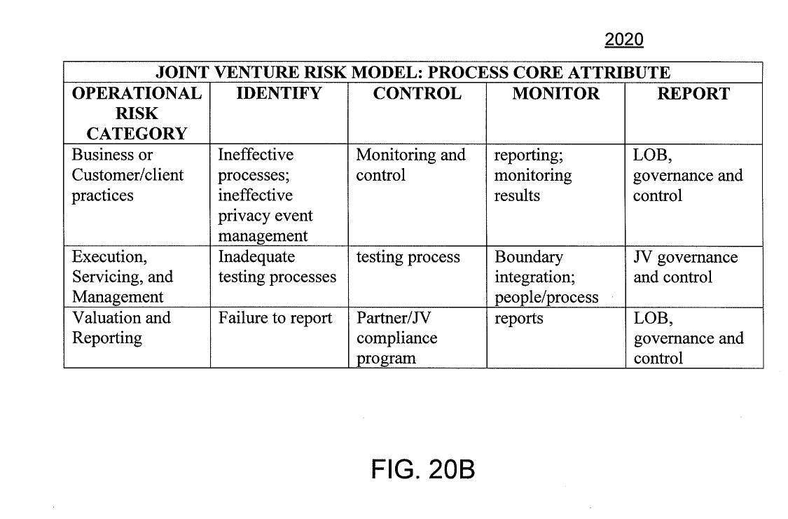

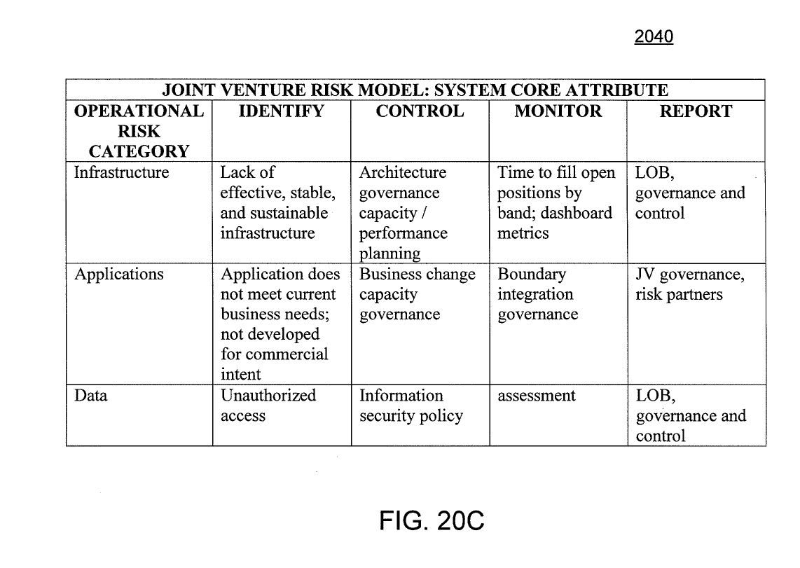

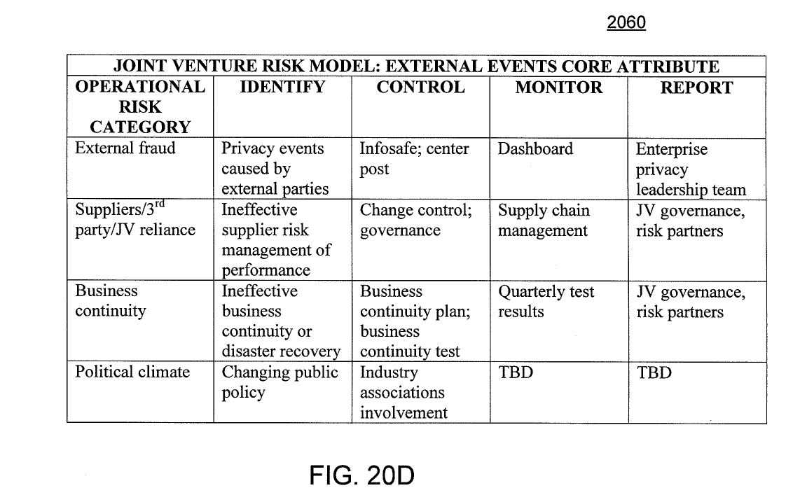

At block 1601, framework risks may be identified against a set of controls to ensure appropriate management of people, process, systems, external, and compliance risks as may be specified in the joint venture's operational risk controls framework (FIG. 20A-D) document. Controls typically are identified to mitigate key risks in a project, process, program, system or function, and may exist in the form of business policies, regulations, and industry best practice documents and cover but are not limited to strategy, governance, architecture, design/build, information security, business continuity, change management, and service delivery/operations. Each control is assessed for its effectiveness and has a primary owner responsible ensuring ongoing monitoring and reporting. A companion compliance program document may be leveraged for the applicable regulatory controls.

As risks are identified, the risks may be prioritized based on risk probability and impact (generally through the corresponding RPN). The risk team may then calculate a score based on additional risk factors, including regulatory, reputation, customer, and financial impact. This score may then be reviewed and validated by the risk owners.

Processes for identifying risk may leverage existing audit and change management routines and any regulatory review or exam findings.

Blocks 1602-1607 are typically performed by a change management organization. At blocks 1602 and 1603, the identified risks are tracked, and the risks are assigned to the appropriate business or owner. For example, a risk may be assigned to one of the partner businesses or to the joint venture itself.

When a control that is meant to prevent or mitigate a defined risk is not in place, a control gap typically exists. Control gaps may be prioritized and mitigation plans are addressed through the mitigation process of the framework. Risks may be identified as being owned by one of the partner businesses or by the joint venture. High risk control gaps (defined by risk appetite) may be reviewed by a risk and compliance steering committee.

At blocks 1604 and 1605, mitigation plans may be developed for all high priority risk items and approved by the owning unit and reviewed by the risk and compliance steering committee. A mitigation plan typically contains the components including actionable milestones required to address the risk, clearly defined owners for each action item, deliverable dates, defined review routines, and control plan. The mitigation plan may then be managed through the enterprise change management process.

Risk owners may leverage a risk process for acceptance if mitigation is not deemed feasible. Escalation may follow the LOB process but typically is initially addressed through either of the partner's risk governance structure. Risks may be classified as audit issues, “Just Do It”, “Continuous Monitoring”, or “Emerging Risk.” Issues whose risk scores equate to a severity 1 or severity 2 level after mitigation typically follow the self-identified audit process.

Blocks 1608-1613 are typically performed by a designated risk lead group of a partner company. Identified risks (as determined at block 1601) may be incorporated in updates to the joint venture framework, risk profile, and controls.

Blocks 1614-1620 are typically performed by a compliance group for the joint venture. A risk and compliance steering committee may perform monitoring activities to ensure appropriate progress is being made and risk is being reduced as defined. Monitoring may include:
Bi-Weekly: Review of high risk mitigation plans; review and scoring of newly identified high risk items.
Monthly risk identification review and scorecard production.
Quarterly: Review of controls framework for policy, regulatory, emerging risks or other changes for risks that may have impacts on the process, project, program, system or function.
Annually: Coordinated risk assessment of the joint venture, where the schedule is determined by global supply chain requirements.

Risk reporting may be generated at different intervals with different degrees of detail. For example, a monthly risk and compliance steering committee detailed scorecard may include the residual risk score and mitigation status for all identified risks. A monthly senior executive steering committee risk scorecard may include the residual risk score and mitigation status on primary operational risk categories.

Significant decisions and risk issues may be escalated to a program steering committee and senior executive steering committee as needed.

At block 1621, the executive steering committee reviews and approves escalated issues and associated mitigation plans.

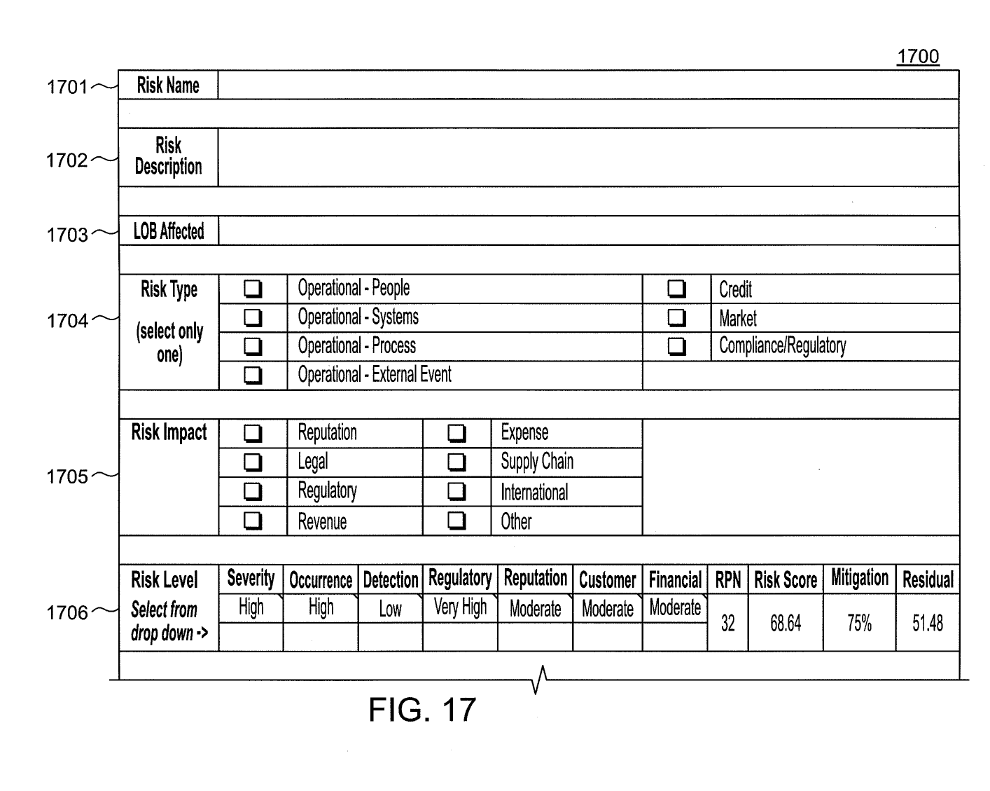

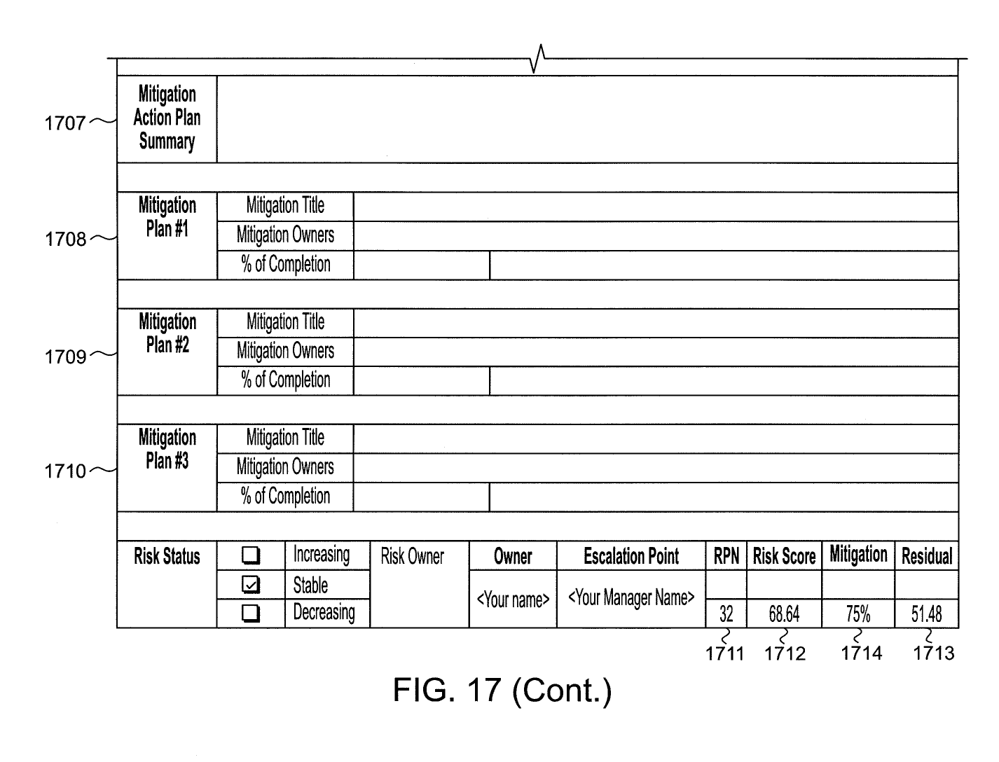

FIG. 17 shows risk identification template 1700 in accordance with an aspect of the invention. Template 1700 includes entries 1702-1710 for entering risk information for identified risk 1701 that is associated with a joint venture. Based on the risk level information 1706, computer system 100 determines RPN 1711, risk score 1712, mitigation percentage 1714, and residual score 1713. As previously discussed, risk score 1712 is inherent for the identified risk and may be reduced as mitigation action items in the mitigation plan (corresponding to mitigation action plan summary 1707, and mitigation plan items 1708-1710) are completed (as reflected by mitigation percentage 1714) to obtain residual score 1713.

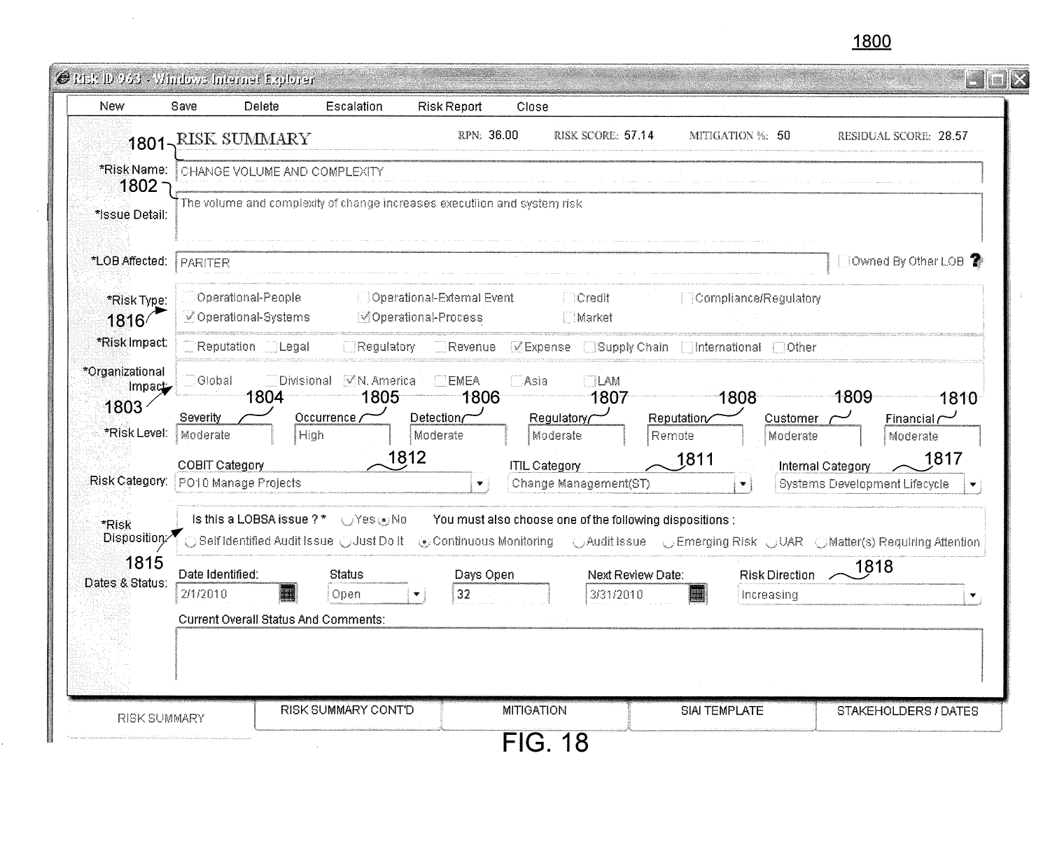

FIG. 18 illustrates screen shot 1800 for a risk summary in accordance with an aspect of the invention. Risk information may be entered directly into fields 1801-1818 of screen shot 1800 or may be entered through template 1700.

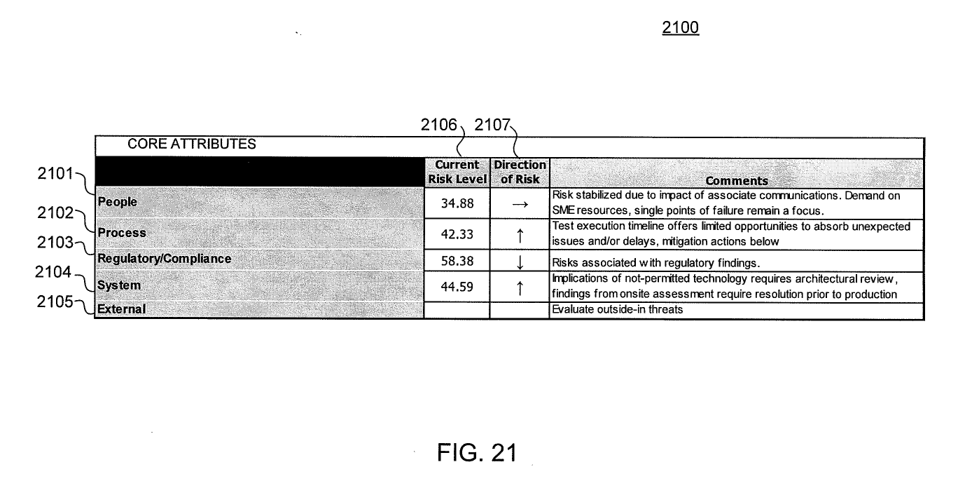

Identified risks may be mapped into different risk groups so that identified risks in each group may be analyzed to provide a quantitative measure of the risks in the group. For example, risks may be grouped by core attributes (corresponding to risk type 1705 as shown in FIG. 17 and risk type 1816 as shown in FIG. 18). Illustrative core attributes include people, process, systems, and external events as modeled by a joint venture risk model in FIGS. 20A-D, respectively. A risk scorecard may then be obtained in which the current risk score is determined for each core attribute as shown in FIG. 21.

Core attributes correspond to the primary categories of operational risk. For example, an operational risk may be the risk of loss resulting from inadequate or failed internal processes, people and systems or from external events. A business may classify operational risk by:
People risk—The risk that business objectives may not be met due to human resource deficiencies such as: turnover; untrained personnel; over-reliance on key personnel; inadequate staffing numbers; employment practices; workplace safety; complexity of services, processes and governance structure; internal fraud; and deficiencies in management.
Process risk—The risk that a pre-determined process necessary to conduct business does not function properly or leads to undesired results. Process risk may include risk related to clients, products, business practices, execution, delivery, process management, system conversions, outsourcing, disruptive market competition, new or changing products and services that impact the growth of a business.
Systems risk—The risk that arises from systems and/or tools that are deficient, unstable or overly complex for the intended user and are important to conducting the activities of a business. Systems risk can extend to include systemic risk, business disruption, technology complexity, business line interdependence, geographic diversity, payments and settlements. Systems risk can arise from the introduction of new technologies into the infrastructure of a business.
External events risk—The risk that arises from factors outside of the span of control for a business. This includes risks associated with vendors and service providers, as well as political, social, cultural and environmental factors.

From the risk score card, a user may evaluate the relative risk urgency over the different core attributes. Based on current risk level 2106, a user may wish to focus on identified risks in the regulatory/compliance group because the risk level is the highest. However, the urgency may be tempered because risk direction 2107 is decreasing. Risk direction 2107 may be affected by different factors, including mitigation actions items that should be completed in the near future.

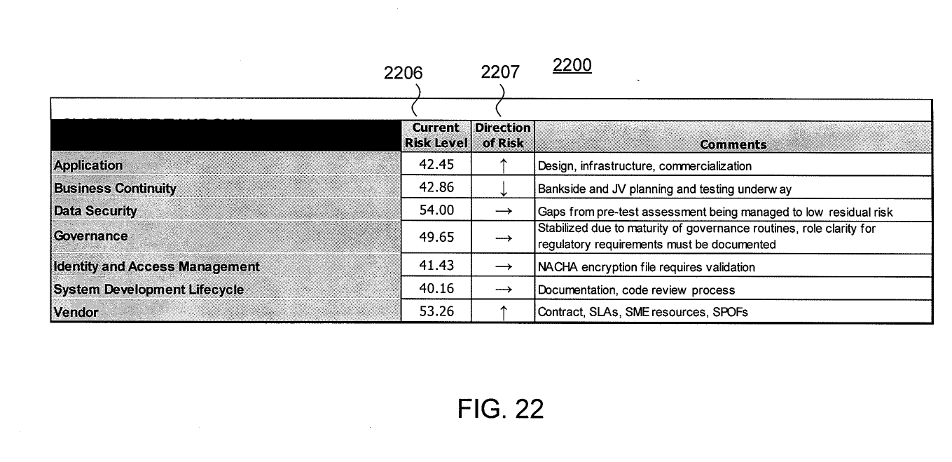

Risks may also be grouped differently so that identified risks can be analyzed and reported by different sets of attributes. For example, risks may be grouped by internal risk category 1817. Internal risk categorization may include application (risk to a technology application that is not adequately protected), identity and access management (risk that users will not be properly authenticated or unauthorized users may get access to confidential information), server network, business continuity (risk that a system or service may be interrupted), vendor (risks owned by a 3^{rd} party that could negatively impact the partner), data security, governance (risks that appropriate oversight and escalation is not in place), and system development lifecycle (risk that systems and applications are developed insecurely.) The risk scorecard may further include a risk summary for the different internal risk categories in a joint venture as shown in FIG. 22. Based on current risk level 2206 and risk direction 2207, a degree of urgency may be associated with each internal risk category.

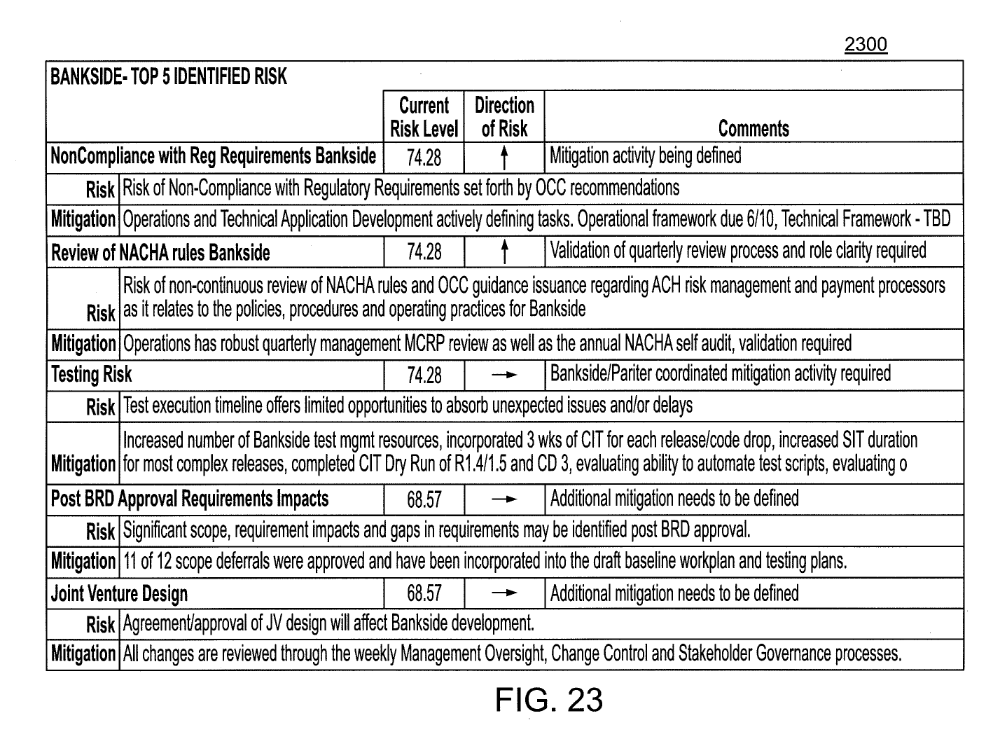

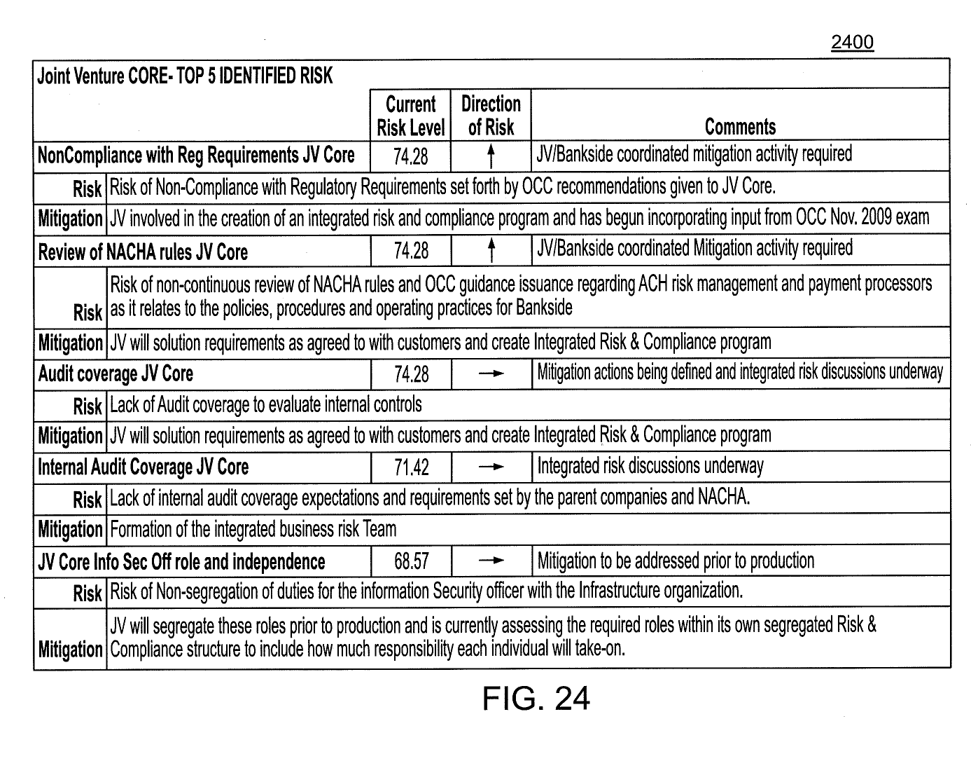

The risk scorecard may include different scoring components including a risk summary per core attribute (e.g., summary 2100 as shown in FIG. 21), a risk summary per internal risk category (e.g., summary 2200 as shown in FIG. 22), a prioritized risk listing for the highest level risks for one of the partner businesses (denoted by “bankside”) (e.g., list 2300 as shown as FIG. 23), and a prioritized risk listing for the joint venture itself (e.g., list 2400 as shown in FIG. 24). The joint venture may encompass an IT system and as well as processes, people, and other systems associated with the IT system.

FIG. 19 shows flow chart 1900 for assessing risks for a joint venture in accordance with an aspect of the invention. At block 1901, risk information is obtained for the joint venture through data entries in template 1700 and/or screen shot 1800. At block 1902, identified risks may be associated with the development and maintenance of the joint venture itself or to one or both of the partner businesses of the joint venture. For example, an IT system for the joint venture is typically implemented and maintained in accordance with a contract between the partner businesses. A capability that is not specified in the joint venture contract may have significant importance to one of the partner businesses. Consequently, the capability may not result in an identified risk for the joint venture but may result in an identified risk for one of the partner businesses.

The identified risks may be prioritized according to the risk score at block 1903. Risks are typically prioritized by risk score; however, the prioritization may be adjusted by the risk direction. For example, the prioritization of risks may be decreased with decreasing risk direction or increased with increasing risk direction. Based on the prioritization, a high risk category may be identified, where a risk category is specified by a standardized risk framework (e.g., Information Technology Infrastructure Library (ITIL)).

At block 1904 controls are mapped to the risks in a high risk category. If a control is missing, as determined at block 1905, a mitigation plan may be invoked to eliminate the high risk control gap at block 1906.

FIGS. 20A-D shows a risk model in a joint venture in accordance with an aspect of the invention. The risk model includes risk components 2000, 2020, 2040, and 2060 according to core attributes based on operational risk category 2001, identity 2002, control 2003, monitor 2004, and report 2005. The associated control typically mitigates the risk level of the risk.

With an aspect of the invention, the Operational Risk Category may be based on ITIL, Basel II, COBIT or other frameworks but are stated in terms of risks vs. controls. For example, some risks may be associated with an internal fraud category 2006.

As previously discussed, FIGS. 21-24 illustrate a risk scorecard. FIG. 21 illustrates a summary for core attributes in a joint venture in accordance with an aspect of the invention. FIG. 21 shows summary 2100 for risks by core attributes 2101-2105 in a joint venture in accordance with an aspect of the invention. Computer system 100 may determine risk level 2106 for each core attribute 2101-2105. For example, the risk score may be averaged for all of the risks associated with the core attribute to obtain the risk level. FIGS. 22, 23, and 24 show a summary for risks by internal risk categories in the joint venture, risks with a highest risk level for a partner business, and risks with a highest risk level for the joint venture, respectively, in accordance with an aspect of the invention.

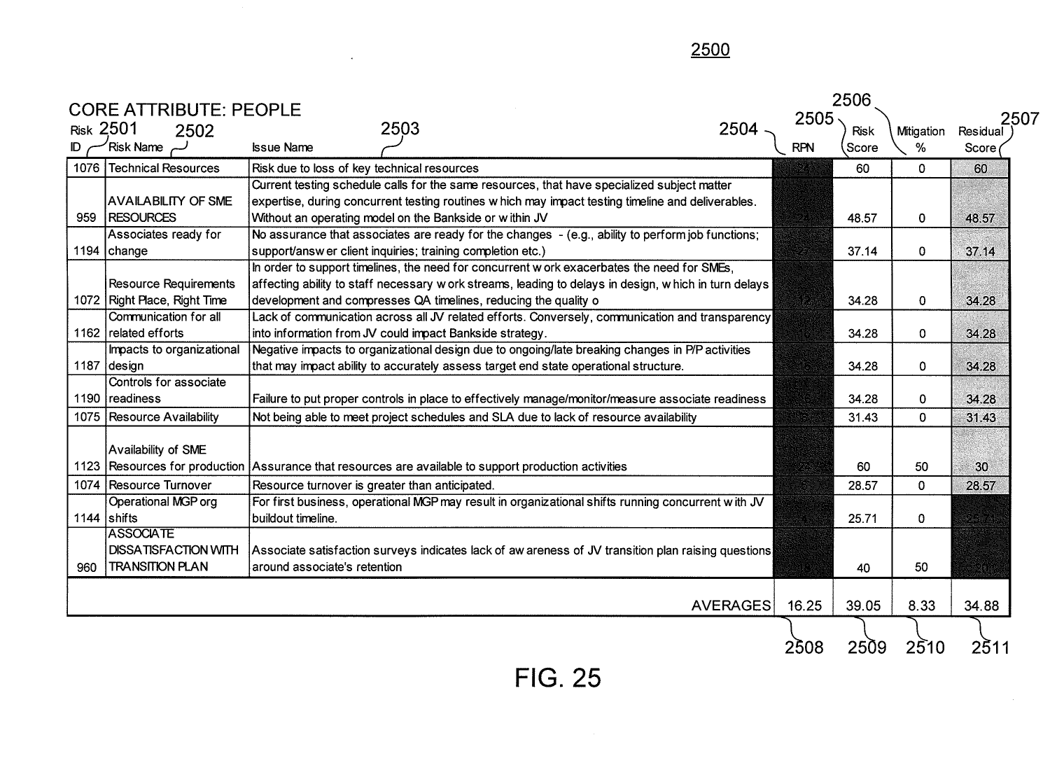

FIG. 25 shows list 2500 of risks associated with the people core attribute in accordance with as aspect of the invention. A user may obtain greater detail of the risks than what is provided by the scorecard. List 2500 displays information for each risk by risk id 2501, risk name 2502, issue name 2503, and scoring information 2504-2507. Each score 2404-2507 may be averaged in fields 2508-2511, respectively.

Scoring for each of the risks may be displayed by risk appetite according to the current risk level, which is function of RPN (severity, occurrence, detection), regulatory, reputation, customer, and financial components. For example, the risk level may be color-coded as red, yellow, or green when the value is >=64, between 28 and 63, or <=27, respectively. Red and yellow may be indicative of varying degrees of escalation, and green may be indicative of business as usual and monitoring as needed.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. A computer-assisted method comprising:
obtaining, by a risk assessment computer system, risk information for a plurality of identified risks for an information technology system, the information technology system providing separate operations for a first business and a second business;
identifying a first identified risk of the plurality of identified risks, the first identified risk owned by a joint venture;
identifying a second identified risk of the plurality of identified risks, the second identified risk owned by the first business; and
assigning the first identified risk and the second identified risk based on risk ownership.

2. The method of claim 1, further comprising:
partitioning the plurality of identified risks by a plurality of core attributes for a risk model.

3. The method of claim 2, further comprising:
determining a risk level for one of the plurality of core attributes.

4. The method of claim 3, wherein the determining comprises:
averaging risk scores for identified risks associated with said one of the plurality of core attributes.

5. The method of claim 1, further comprising:
partitioning the plurality of identified risks into a plurality of internal risk categories.

6. The method of claim 5, further comprising:
determining a risk level for one of the internal risk categories.

7. The method of claim 6, wherein the determining comprises:
averaging risk scores for identified risks associated with said one of the internal risk categories.

8. The method of claim 1, further comprising:
prioritizing the plurality of identified risks according to a risk score, the risk score based on a risk priority number and a plurality of additional risk factors.

9. The method of claim 8, wherein the plurality of additional risk factors include a regulatory risk factor, a reputation risk factor, a customer risk factor, and a financial impact risk factor.

10. The method of claim 1, wherein the mitigating comprises:
obtaining at least one actionable milestone associated with one of the plurality of identified risks;
mitigating said one of the plurality of identified risks when the at least one actionable milestone has been completed; and
adjusting a residual score for said one of the plurality of identified risks when the at least one actionable milestone has been completed.

11. The method of claim 1, further comprising:
comparing an operational risk profile for the joint venture with risk policies of the first business, wherein the operational risk profile includes the plurality of identified risks against a set of controls; and
identifying any discrepancies from the comparing.

12. The method of claim 11, wherein the comparing further comprises:
comparing the operational risk profile with at least one standard risk framework.

13. A computer-assisted method comprising:
obtaining, by a risk assessment computer system, risk information for a plurality of identified risks for an information technology system, the information technology system providing separate operations for a first business and a second business;
prioritizing the plurality of identified risks according to a risk score for each identified risk, the plurality of identified risks including a first identified risk;
when the first identified risk is categorized in a high priority risk category based on the prioritizing, identifying a control reducing a risk level for the first identified risk;
when the control is not installed, identifying a high risk control gap; and
tracking a mitigation plan to eliminate the high risk control gap.

14. The method of claim 13, wherein the tracking comprises:
obtaining at least one actionable milestone associated with one of the plurality of identified risks, wherein said one of the plurality of identified risks is mitigated when the at least one actionable milestone has been completed; and
adjusting a residual score for said one of the plurality of identified risks when the at least one actionable milestone has been completed.

15. The method of claim 14, wherein the at least one actionable milestone includes installing a control within the information technology system for controlling said one of the plurality of identified risks.

16. The method of claim 13, wherein the risk score is based on a risk priority number and at least one additional risk factor.

17. The method of claim 16, wherein the at least one additional risk factor is selected from the group consisting of a regulatory risk factor, a reputation risk factor, a customer risk factor, and a financial impact risk factor.

18. An apparatus comprising:
at least one memory; and
at least one processor coupled to the at least one memory and configured to perform, based on instructions stored in the at least one memory:
obtaining, by a risk assessment computer system, risk information for a plurality of identified risks for an information technology system, the information technology system providing separate operations for a first business and a second business;
identifying a first identified risk of the plurality of identified risks, the first identified risk owned by a joint venture;
identifying a second identified risk of the plurality of identified risks, the second identified risk owned by the first business;
assigning the first identified risk and the second identified risk based on risk ownership; and
prioritizing the plurality of identified risks according to a risk score for each identified risk.

19. The apparatus of claim 18, wherein the at least one processor is further configured to perform:
when the first identified risk is categorized in a high priority risk category based on the prioritizing, identifying a control reducing a risk level for a first identified risk, wherein the plurality of identified risks includes the first identified risk; and
when the control is not installed, identifying a high risk control gap.

20. The apparatus of claim 19, wherein the at least one processor is further configured to perform:
tracking a mitigation plan to eliminate the high risk control gap.

21. The apparatus of claim 20, wherein the at least one processor is further configured to perform:
obtaining at least one actionable milestone associated with one of the plurality of identified risks; and
adjusting a residual score for said one of the plurality of identified risks when the at least one actionable milestone has been completed, wherein said one of the plurality of identified risks is mitigated when the at least one actionable milestones has been completed.

22. A computer-readable storage medium storing computer-executable instructions that, when executed, cause a processor to perform a method comprising:
obtaining, by a risk assessment computer system, risk information for a plurality of identified risks for an information technology system, the information technology system providing separate operations for a first business and a second business;
identifying a first identified risk of the plurality of identified risks, the first identified risk owned by a joint venture;
identifying a second identified risk of the plurality of identified risks, the second identified risk owned by the first business;
assigning the first identified risk and the second identified risk based on risk ownership;
determining a risk score for each identified risk based on a risk priority number and at least one additional risk factors; and
prioritizing the plurality of identified risks according to the risk score for each identified risk.

23. The computer-readable medium of claim 22, said method further comprising:
when the first identified risk is categorized in a high priority risk category based on the prioritizing, identifying a control reducing a risk level for a first identified risk, wherein the plurality of identified risks includes the first identified risk; and
when the control is not installed, identifying a high risk control gap.

24. The computer-readable medium of claim 23, said method further comprising:
tracking a mitigation plan to eliminate the high risk control gap.

25. The computer-readable medium of claim 24, said method further comprising:
obtaining at least one actionable milestone associated with one of the plurality of identified risks; and
adjusting a residual score for said one of the plurality of identified risks when the at least one actionable milestone has been completed, wherein said one of the plurality of identified risks is mitigated when the at least one actionable milestones has been completed.
